(19) United States
(12) Patent Application Publication
(10) Pub. No.: US 2013/0039416 A1
(43) Pub. Date: Feb. 14, 2013

(54) IMAGE ENCODING APPARATUS, IMAGE ENCODING METHOD AND PROGRAM

(71) Applicant: Kiyoto Someya, Tokyo (JP)

(72) Inventor: Kiyoto Someya, Tokyo (JP)

(21) Appl. No.: 13/562,010

(22) Filed: Jul. 30, 2012

(30) Foreign Application Priority Data
Aug. 9, 2011 (JP) 2011-173566

(51) Int. Cl. H04N 7/32

(52) U.S. Cl. 375/240.12; 375/E07.243

(57) ABSTRACT

Provided is an image encoding apparatus including a characteristic quantity generation unit that generates a characteristic quantity showing a correlation between pictures for each candidate of a reference picture, with a first viewpoint picture different in time direction from the first viewpoint picture and a second viewpoint picture different from the first viewpoint picture being set as the candidates of the reference picture, and a reference picture list generation unit that generates a reference picture list by selecting as many reference pictures for the first viewpoint picture as the reference pictures for the second viewpoint picture from the candidates of the reference pictures based on the characteristic quantity.

### BACKGROUND

The present technology relates to an image encoding apparatus, an image encoding method, and a program. In particular, the generation of a reference picture list is made possible by selecting reference picture candidates in the time direction or the parallax direction for the number of reference pictures of the other viewpoint so as to improve encoding efficiency.

In recent years, apparatuses handling image information as digital data and conforming to a method like MPEG2 (ISO (International Organization for Standardization)/IEC (International Electrotechnical Commission)13818-2) that compresses the image information by the orthogonal transformation such as a discrete cosine transform and the motion compensation by using redundancy specific to the image information for the purpose of efficiently transmitting and storing information are widely used on both sides of information delivery by broadcasting stations and the like and information reception by ordinary households. Also, the method called H.264 and MPEG4 Part10 (AVC (Advanced Video Coding)) (hereinafter, called “H.264/AVC”) capable of realizing high encoding efficiency is increasingly used, though more amounts of operation are necessary for encoding decoding thereof than MPEG2 or the like.

According to such a compression and encoding method, inter-screen prediction encoding using reference pictures is used and in the H.264/AVC, for example, a reference picture can be selected from a plurality of encoded pictures. Each selected reference picture is managed by a variable called a reference index.

According to Japanese Patent Application Laid-Open No. 2010-63092, the reference index is allocated between two reference pictures contained in a plurality of reference pictures in accordance with a temporal distance from the picture to be encoded so that image quality and encoding efficiency can be improved.

### SUMMARY

When compressing and encoding dynamic images, compression and encoding of dynamic images of not only one viewpoint, but also a plurality of viewpoints is used. In compression and encoding of dynamic images of a plurality of viewpoints, dynamic images of one of the viewpoints are set as a base view, dynamic images of the other viewpoint are set as dependent views, and pictures of the base view or encoded pictures of the plurality of viewpoints are used as reference pictures.

If the number of reference pictures of the base view using reference pictures in the time direction only and that of a dependent view capable of using reference pictures in the time direction or the parallax direction are made equal, the amount of processing of the base view and that of the dependent view can be made equivalent. Therefore, when the base view and the dependent view are alternately used for encoding by an encoder, control such as switching is made easier because the amount of processing is equivalent therebetween. If an encoder is provided for each of the base view and the dependent view for encoding, it is not necessary to use an encoder with higher processing capabilities for encoding the dependent view than the encoder for encoding the base view because the amount of processing is equivalent therebetween. However, if the number of reference pictures of the dependent view is restricted and made equal to that of the base view, a problem of how to select reference pictures arises.

Thus, it is desirable to provide an image encoding apparatus capable of generating a reference picture list by selecting reference picture candidates in the time direction or the parallax direction for the number of reference pictures of the other viewpoint so as to improve encoding efficiency, an image encoding method, and a program.

According to an embodiment of the present technology, there is provided an image encoding apparatus including a characteristic quantity generation unit that generates a characteristic quantity showing a correlation between pictures for each candidate of a reference picture, with a first viewpoint picture different in time direction from the first viewpoint picture and a second viewpoint picture different from the first viewpoint picture being set as the candidates of the reference picture, and a reference picture list generation unit that generates a reference picture list by selecting as many reference pictures for the first viewpoint picture as the reference pictures for the second viewpoint picture from the candidates of the reference pictures based on the characteristic quantity.

An image encoding apparatus according to the present technology calculates a characteristic quantity, for example, a SAD value or SATD value showing a correlation between pictures for each candidate of reference pictures, with a reference picture different in time direction from a first viewpoint picture, for example, a dependent view picture and a reference picture of a second viewpoint picture, for example, a base view different from the first viewpoint picture being set as the candidates of the reference picture. A reference picture list is generated by selecting as many reference pictures for the dependent view picture as the reference pictures for the base view picture from the candidates of the reference pictures based on the characteristic quantity. If a determinant value based on the characteristic quantity for a case where the dependent view picture is a GOP starting picture is equal to or less than a threshold, base view pictures, that is, reference pictures in the parallax direction are included in the reference picture list for the next picture. If the determinant value is larger than the threshold, the reference picture list includes only reference pictures in the time direction for the next picture. As another method, a pattern of reference pictures is updated or the pattern of reference pictures immediately before is maintained based on a comparison result between a determinant value based on the characteristic quantity obtained when the first viewpoint picture is a first picture and a threshold.

If reference pictures of the base view are included in the reference picture list, the characteristic quantity for a case where reference pictures of the base view are included is maintained and if the reference picture list contains only reference pictures in the time direction for a predetermined period, the held characteristic quantity is updated with the characteristic quantity calculated for an anchor picture.

If the reference picture list of the picture contains only reference pictures in the time direction, the characteristic quantity calculated for the picture and the held characteristic quantity are compared and reference pictures for the next picture are selected based on a comparison result. Further, if the reference picture list of the picture includes reference pictures of the base view, the characteristic quantity of only reference pictures in the time direction is estimated and reference pictures for the next picture are selected based on a comparison result between the estimated characteristic quantity and the characteristic quantity for a case where reference pictures of the base view are included. The estimated characteristic quantity is calculated by generating in advance estimation processing information by using the characteristic quantity for a case where the reference picture list for the dependent view picture contains only reference pictures in the time direction and the characteristic quantity for pictures of the base view and using the characteristic quantity of the base view picture corresponding to the dependent view picture estimating the characteristic quantity and the estimation processing information. If a state in which reference pictures of the base view are contained in a reference picture list continues for a predetermined period, the reference picture list is updated by including only reference pictures in the time direction.

Further, if the first and second pictures are interlaced materials and the reference picture list contains reference pictures of the base view, reference pictures in phase or in opposite phase are selected from the reference pictures in the time direction based on the characteristic quantity. The ratio of reference index or the like is also used as the characteristic quantity.

According to another embodiment of the present technology, there is provided an image encoding method including generating a characteristic quantity showing a correlation between pictures for each candidate of a reference picture, with a first viewpoint picture different in time direction from the first viewpoint picture and a second viewpoint picture different from the first viewpoint picture being set as the candidates of the reference picture, and generating a reference picture list by selecting as many reference pictures for the first viewpoint picture as the reference pictures for the second viewpoint picture from the candidates of the reference pictures based on the characteristic quantity.

According to another embodiment of the present technology, there is provided a program for causing a computer to perform encoding processing of first and second viewpoint pictures by using a reference picture list, the program causing the computer to execute procedures of generating a characteristic quantity showing a correlation between pictures for each candidate of a reference picture, with the first viewpoint picture different in time direction from the first viewpoint picture and the second viewpoint picture different from the first viewpoint picture being set as the candidates of the reference picture, and generating the reference picture list by selecting as many reference pictures for the first viewpoint picture as the reference pictures for the second viewpoint picture from the candidates of the reference pictures based on the characteristic quantity.

A program according to the present technology is, for example, a program that can be provided by a storage medium or communication medium in a computer readable form, for example, by a storage medium such as an optical disk, magnetic disk, and semiconductor memory or a communication medium such as a network to a general-purpose computer that can execute various kinds of program code. By providing such a program in a computer readable form, processing in accordance with the program is realized on the computer.

According to the present technology, a characteristic quantity generation unit calculates a characteristic quantity showing a correlation between pictures is calculated for each candidate of reference pictures, with a first viewpoint picture different in time direction from the first viewpoint picture and a second viewpoint picture different from the first viewpoint picture being set as the candidates of the reference picture. A reference picture list generation unit generates a reference picture list by selecting as many reference pictures for the first viewpoint picture as the reference pictures for the second viewpoint picture from the candidates of the reference pictures based on the characteristic quantity. Therefore, a reference picture list in which the number of reference pictures is equal to that of the second viewpoint picture can be generated by selecting reference pictures from candidates of reference pictures in the time direction and the parallax direction in such a way that encoding efficiency is improved.

### BRIEF DESCRIPTION OF THE DRAWINGS

FIG. 1 is a diagram showing a configuration of an embodiment of an image encoding apparatus;

FIG. 2 is a flow chart showing an image encoding processing operation;

FIG. 3 is a diagram showing the configuration of a characteristic quantity generation unit;

FIG. 4 is a diagram showing the configuration of a reference picture list generation unit;

FIG. 5 is a flow chart showing an operation of the reference picture list generation unit;

FIG. 6 is a diagram showing a general reference relationship between a base view and a dependent view;

FIG. 7 is a diagram illustrating the reference relationship when the base view and the dependent view are made to have an equal number of reference pictures;

FIG. 8 is a diagram showing the reference relationship of the first picture;

FIG. 9 is a diagram showing a case where a discriminant value is larger than a threshold;

FIG. 10 is a diagram showing a case where the discriminant value is equal to or less than the threshold;

FIG. 11 is a diagram showing a case where a reference picture in a line of sight is never adopted as a pattern containing a reference picture in a parallax direction in a predetermined period immediately before;

FIG. 12 is a diagram showing a case where the current picture contains only time predictions;

FIG. 13 is a diagram showing a case where the current picture contains a parallax prediction;

FIG. 14 is a diagram showing a case where the current picture in the B picture contains only time predictions;

FIG. 15 is a diagram showing a case where estimation processing information is updated by setting the reference pattern as a pattern of only reference pictures in the time direction;

FIG. 16 is a diagram showing the reference relationship the base view and the dependent view are interlaced materials;

FIG. 17 is a diagram illustrating the reference relationship when the base view and the dependent view in the interlaced material are made to have an equal number of reference pictures;

FIG. 18 is a diagram showing the reference relationship of the first picture of a top field in the dependent view;

FIG. 19 is a diagram showing the reference relationship of the first picture of a bottom field in the dependent view;

FIG. 20 is a diagram showing processing of the first picture of the bottom field in the dependent view;

FIG. 21 is a diagram showing a case where the current picture contains only time predictions;

FIG. 22 is a diagram showing a case where the current picture contains a parallax prediction;

FIG. 23 is a diagram illustrating the reference relationship when the base view and the dependent view in the interlaced material are made to have an equal number of reference pictures including B pictures;

FIG. 24 is a flow chart showing the operation when the ratio of reference index is used as a characteristic quantity;

FIG. 25 is a flow chart showing the operation to determine whether to select a reference picture in phase or in opposite phase with the parallax by using the ratio of reference index;

FIG. 26 is a diagram exemplifying the schematic configuration of a recording and reproducing apparatus; and

FIG. 27 is a diagram exemplifying the schematic configuration of an imaging apparatus.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

An embodiment to carry out the present technology will be described below. The description will be provided in the order shown below:

1. Configuration of Image Encoding Apparatus

2. Operation of Image Encoding Apparatus

3. Configuration and Operation of Characteristic Quantity Generation Unit

4. Configuration and Operation of Reference Picture List Generation Unit

5. Operation When Progressive Material Is Used

6. Operation When Interlaced Material Is Used

7. Other Determination Operations of Reference Pattern

8. Software Processing

9. Application Examples

### 1. Configuration of Image Encoding Apparatus

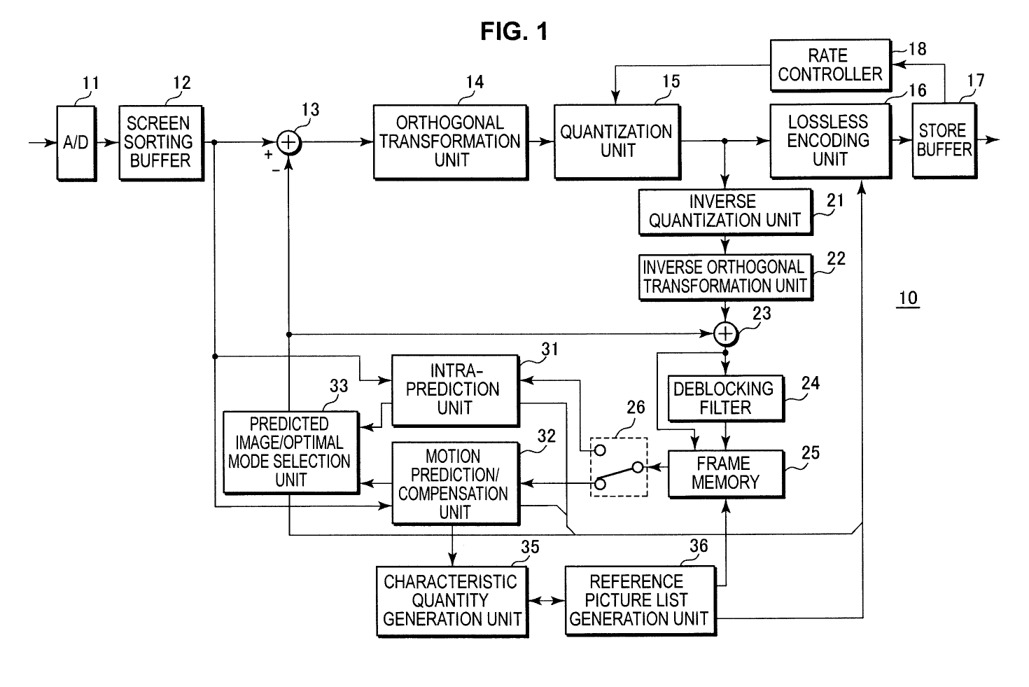

FIG. 1 shows the configuration of an embodiment of an image encoding apparatus according to the present technology. An image encoding apparatus 10 includes an analog/digital converter (A/D converter) 11, a screen sorting buffer 12, a subtractor 13, an orthogonal transformation unit 14, a quantization unit 15, a lossless encoding unit 16, a store buffer 17, and a rate controller 18. Further, the image encoding apparatus 10 includes an inverse quantization unit 21, an inverse orthogonal transformation unit 22, an adder 23, a deblocking filter processing unit 24, a frame memory 25, a selector 26, an intra-prediction unit 31, a motion prediction/compensation unit 32, a predicted image/optimal mode selection unit 33, a characteristic quantity generation unit 35, and a reference picture list generation unit 36.

The A/D converter 11 converts an analog image signal into digital image data and outputs the digital image data to the screen sorting buffer 12.

The screen sorting buffer 12 sorts frames of image data output from the A/D converter 11. The screen sorting buffer 12 sorts frames in accordance with a GOP (Group of Pictures) associated with encoding processing and outputs the sorted image data to the subtractor 13, the intra-prediction unit 31, and the motion prediction/compensation unit 32.

The image data output from the screen sorting buffer 12 and predicted image data selected by the predicted image/optimal mode selection unit 33 described later are supplied to the subtractor 13. The subtractor 13 calculates predicted error data as a difference between image data output from the screen sorting buffer 12 and predicted image data supplied from the predicted image/optimal mode selection unit 33 and outputs the predicted error data to the orthogonal transformation unit 14.

The orthogonal transformation unit 14 performs orthogonal transformation processing such as a discrete cosine transform (DCT) and Karhunen-Loeve transform on predicted error data output from the subtractor 13. The orthogonal transformation unit 14 outputs conversion factor data obtained by performing orthogonal transformation processing to the quantization unit 15.

The quantization unit 15 has conversion factor data output from the orthogonal transformation unit 14 and a rate control signal from the rate controller 18 described later supplied thereto. The quantization unit 15 quantizes the conversion factor data and outputs the quantized data to the lossless encoding unit 16 and the inverse quantization unit 21. The quantization unit 15 changes the bit rate of quantized data by switching quantization parameters (quantization scale) based on a rate control signal from the rate controller 18.

The lossless encoding unit 16 has quantized data output from the quantization unit 15 and prediction mode information from the intra-prediction unit 31, the motion prediction/compensation unit 32, the predicted image/optimal mode selection unit 33 supplied thereto. The prediction mode information includes a macro block type that enables identification of the predicted block size in accordance with intra-prediction or inter-prediction, the prediction mode, motion vector information, and reference picture information. The lossless encoding unit 16 performs lossless encoding processing by, for example, variable-length coding or arithmetic coding on quantized data to generate an encoded stream and outputs the encoded stream to the store buffer 17. Also, the lossless encoding unit 16 losslessly encodes and includes prediction mode information and reference picture list information supplied from the reference picture list generation unit 36 described later in an encoded stream.

The store buffer 17 stores an encoded stream from the lossless encoding unit 16. Also, the store buffer 17 outputs the stored encoded stream at a transmission speed in accordance with the transmission path.

The rate controller 18 monitors for free space of the store buffer 17 and generates a rate control signal in accordance with the free space to output the rate control signal to the quantization unit 15. The rate controller 18 acquires information indicating free space from, for example, the store buffer 17. If the free space is small, the rate controller 18 lowers the bit rate of quantized data by a rate control signal. If the free space of the store buffer 17 is sufficiently large, the rate controller 18 raises the bit rate of quantized data by a rate control signal.

The inverse quantization unit 21 performs inverse quantization processing on quantized data supplied from the quantization unit 15. The inverse quantization unit 21 outputs the conversion factor data obtained by performing inverse quantization processing to the inverse orthogonal transformation unit 22.

The inverse orthogonal transformation unit 22 outputs data obtained by performing inverse orthogonal transformation processing on conversion factor data supplied from the inverse quantization unit 21 to the adder 23.

The adder 23 adds data supplied from the inverse orthogonal transformation unit 22 and predicted image data supplied from the predicted image/optimal mode selection unit 33 to generate decoded image data and outputs the decoded image data to the deblocking filter processing unit 24 and the frame memory 25.

The deblocking filter processing unit 24 performs filter processing to decrease block distortion generated when images are encoded. The deblocking filter processing unit 24 performs filter processing to remove block distortion from decoded image data supplied from the adder 23 and outputs the image data after the filter processing to the frame memory 25.

The frame memory 25 holds decoded image data supplied from the adder 23 and decoded image data after the filter processing supplied from the deblocking filter processing unit 24 as image data of reference images.

The selector 26 supplies reference image data before the filter processing read from the frame memory 25 to make an intra-prediction to the intra-prediction unit 31. Also, the selector 26 supplies reference image data after the filter processing read from the frame memory 25 to make an inter-prediction to the motion prediction/compensation unit 32.

The intra-prediction unit 31 performs intra-prediction processing of all intra-prediction modes to be candidates by using image data of images to be encoded output from the screen sorting buffer 12 and reference image data before the filter processing read from the frame memory 25. Further, the intra-prediction unit 31 calculates a cost function value for each intra-prediction mode and selects the intra-prediction mode with the minimum calculated cost function value, that is, the intra-prediction mode in which the best encoding efficiency is achieved as the optimal intra-prediction mode. The intra-prediction unit 31 outputs predicted image data generated in optimal intra-prediction mode, prediction mode information about the optimal intra-prediction mode, and the cost function value in optimal intra-prediction mode to the predicted image/optimal mode selection unit 33. Also, the intra-prediction unit 31 outputs prediction mode information about the intra-prediction mode in intra-prediction processing of each intra-prediction mode to the lossless encoding unit 16 to obtain, as will be described later, the amount of generated code used to calculate the cost function value.

The motion prediction/compensation unit 32 performs motion prediction/compensation processing for all predicted block sizes corresponding to a macro block. The motion prediction/compensation unit 32 detects a motion vector for each image of each predicted block size in an image to be encoded read from the screen sorting buffer 12 by using reference image data after the filter processing read from the frame memory 25. Further, the motion prediction/compensation unit 32 generates a predicted image by performing motion compensation processing on reference images based on the detected motion vector. Also, the motion prediction/compensation unit 32 calculates the cost function value for each predicted block size and selects the predicted block size with the minimum calculated cost function value, that is, the predicted block size in which the best encoding efficiency is achieved as the optimal inter-prediction mode. The motion prediction/compensation unit 32 outputs predicted image data generated in optimal inter-prediction mode, prediction mode information about the optimal inter-prediction mode, and the cost function value in optimal inter-prediction mode to the predicted image/optimal mode selection unit 33. The motion prediction/compensation unit 32 outputs prediction mode information about the inter-prediction mode in inter-prediction processing of each predicted block size to the lossless encoding unit 16 to obtain the amount of generated code used to calculate the cost function value. The motion prediction/compensation unit 32 also makes predictions of the skipped macro block or in direct mode as the inter-prediction mode.

The predicted image/optimal mode selection unit 33 compares the cost function value supplied from the intra-prediction unit 31 and the cost function value supplied from the motion prediction/compensation unit 32 in units of macro blocks and selects the mode with the smaller cost function value as the optimal mode in which the best encoding efficiency is achieved. Also, the predicted image/optimal mode selection unit 33 outputs the predicted image data generated in optimal mode to the subtractor 13 and the adder 23. Further, the predicted image/optimal mode selection unit 33 outputs prediction mode information of the optimal mode to the lossless encoding unit 16.

The characteristic quantity generation unit 35 generates a characteristic quantity showing a correlation between a picture to be encoded and a reference picture. For the generation of a characteristic quantity, for example, a SAD (Sum of Absolute Difference) value as a sum of absolute values of differences calculated to detect a motion vector by the motion prediction/compensation unit 32 or a SATD (Sum of Absolute Transformed Difference) value as a sum of absolute values of differences obtained by performing an Hadamard transform on difference data between encoded pictures and reference pictures is used to generate a characteristic quantity. A global motion vector, which is calculated based on a motion vector detected by the motion prediction/compensation unit 32, may be used as a characteristic quantity. Further, complexity obtained by the rate controller, the ratio of reference index obtained by the predicted image/optimal mode selection unit 33, or camera work (fixed/pan/tilt/zoom), parallax information, or depth information can also be used.

The reference picture list generation unit 36 determines whether to include a picture in the parallax direction in the reference picture list based on a characteristic quantity generated by the characteristic quantity generation unit 35. The reference picture list generation unit 36 makes a determination in each predetermined unit. If, for example, a determination is made for each scene, the reference picture list generation unit 36 discriminates scenes to generate a characteristic quantity for the whole of the same scene before making a determination. If a determination is made for each GOP, the reference picture list generation unit 36 generates a characteristic quantity of the whole GOP before making a determination. Further, if a determination is made for each picture, the reference picture list generation unit 36 generates a characteristic quantity separately for each picture type before making a determination. The reference picture list generation unit 36 generates a reference picture list based on a determination result obtained by making a determination in each predetermined unit and outputs the reference picture list to the lossless encoding unit 16. Also, the reference picture list generation unit 36 performs encoding processing by supplying a reference picture shown in the reference picture list from the memory frame 25 to the motion prediction/compensation unit 32.

### 2. Operation of Image Encoding Apparatus

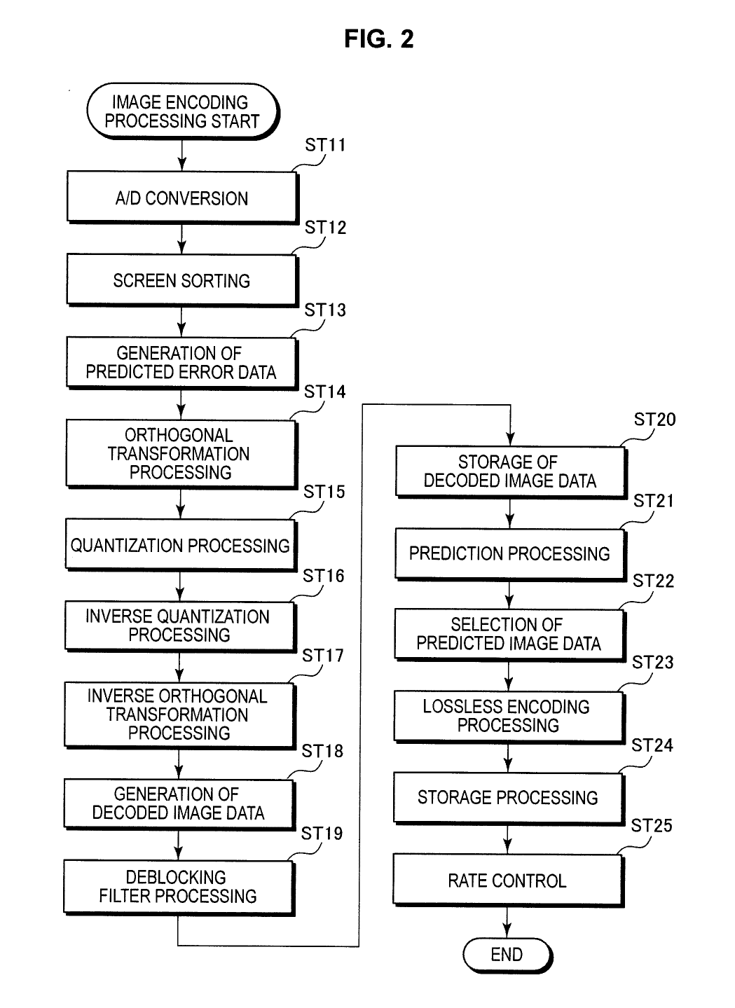

FIG. 2 is a flow chart showing an image encoding processing operation. In step ST11, the A/D converter 11 makes an A/D conversion of an input image signal.

In step ST12, the screen sorting buffer 12 sorts screens. The screen sorting buffer 12 stores image data supplied from the A/D converter 11 to sort the order indicated by each picture into the order of encoding.

In step ST13, the subtractor 13 generates predicted error data. The subtractor 13 generates predicted error data by calculating a difference between image data of images sorted in step ST12 and predicted image data selected by the predicted image/optimal mode selection unit 33. The predicted error data has a smaller amount of data than original image data. Therefore, the amount of data can be compressed when compared with a case of directly encoding images. When the predicted image/optimal mode selection unit 33 selects predicted images supplied from the intra-prediction unit 31 and predicted image from the motion prediction/compensation unit 32 in units of slices, an intra-prediction is made in a slice in which predicted images supplied from the intra-prediction unit 31 are selected. An inter-prediction is made in a slice in which predicted images from the motion prediction/compensation unit 32 are selected.

In step ST14, the orthogonal transformation unit 14 performs orthogonal transformation processing. The orthogonal transformation unit 14 performs an orthogonal transformation of predicted error data supplied from the subtractor 13. More specifically, an orthogonal transformation such as a discrete cosine transform and Karhunen-Loeve transform is performed on predicted error data and conversion factor data is output.

In step ST15, the quantization unit 15 performs quantization processing. The quantization unit 15 quantizes conversion factor data. For the quantization, the rate is controlled, as will be described in processing in step ST25 described later.

In step ST16, the inverse quantization unit 21 performs inverse quantization processing. The inverse quantization unit 21 inversely quantizes conversion factor data quantized by the quantization unit 15 in properties corresponding to properties of the quantization unit 15.

In step ST17, the inverse orthogonal transformation unit 22 performs inverse orthogonal transformation processing. The inverse orthogonal transformation unit 22 performs an inverse orthogonal transformation of conversion factor data inversely quantized by the inverse quantization unit 21 in properties corresponding to properties of the orthogonal transformation unit 14.

In step ST18, the adder 23 generates decoded image data. The adder 23 adds predicted image data supplied from the predicted image/optimal mode selection unit 33 and data after the inverse orthogonal transformation in the position corresponding to the predicted image to generate decoded image data.

In step ST19, the deblocking filter processing unit 24 performs deblocking filter processing. The deblocking filter processing unit 24 removes block distortion by filtering decoded image data output from the adder 23. Also, the deblocking filter processing unit 24 enables vertical filter processing even if the memory capacity of a line memory storing image data is reduced. More specifically, the deblocking filter processing unit 24 controls the image range used for filter operations for a block positioned above a boundary in accordance with the boundary detected by boundary detection between blocks in the vertical direction.

In step ST20, the frame memory 25 stores decoded image data. The frame memory 25 stores decoded image data before the deblocking filter processing.

In step ST21, the intra-prediction unit 31 and the motion prediction/compensation unit 32 each perform prediction processing. That is, the intra-prediction unit 31 performs intra-prediction processing in intra-prediction mode and the motion prediction/compensation unit 32 performs motion prediction/compensation processing in inter-prediction mode. With the above processing, prediction processing in prediction modes as candidates is each performed to calculate each cost function value in prediction modes as candidates. Then, the optimal intra-prediction mode and the optimal inter-prediction mode are selected based on calculated cost function values and predicted images generated in the selected prediction mode, cost functions thereof, and prediction mode information are supplied to the predicted image/optimal mode selection unit 33. In prediction processing, the motion prediction/compensation unit 32 generates predicted images by using reference pictures shown in a reference picture list generated by the reference picture list generation unit 36.

In step ST22, the predicted image/optimal mode selection unit 33 selects predicted image data. The predicted image/optimal mode selection unit 33 decides on the optimal mode in which the best encoding efficiency is achieved based on each cost function value output from the intra-prediction unit 31 and the motion prediction/compensation unit 32. Further, the predicted image/optimal mode selection unit 33 selects predicted image data in the decided optimal mode and supplies the predicted image data to the subtractor 13 and the adder 23. The predicted image is used, as described above, for operations in steps ST13 and ST18.

In step ST23, the lossless encoding unit 16 performs lossless encoding processing. The lossless encoding unit 16 losslessly encodes quantized data output from the quantization unit 15. That is, data is compressed by lossless encoding such as variable-length coding and arithmetic coding being performed on quantized data. At this point, prediction mode information and reference picture list information input into the lossless encoding unit 16 in step ST22 described above is also losslessly encoded. Further, lossless-encoded data of prediction mode information is added to header information of an encoded stream generated by quantized data being losslessly encoded.

In step ST24, the store buffer 17 stores an encoded stream by performing store processing. The encoded stream stored in the store buffer 17 is read when appropriate and transmitted to the decoding side via a transmission path.

In step ST25, the rate controller 18 controls the rate. When an encoded stream is stored by the store buffer 17, the rate controller 18 controls the rate of quantization operation of the quantization unit 15 so that an overflow or underflow should not occur in the store buffer 17.

### 3. Configuration and Operation of Characteristic Quantity Generation Unit

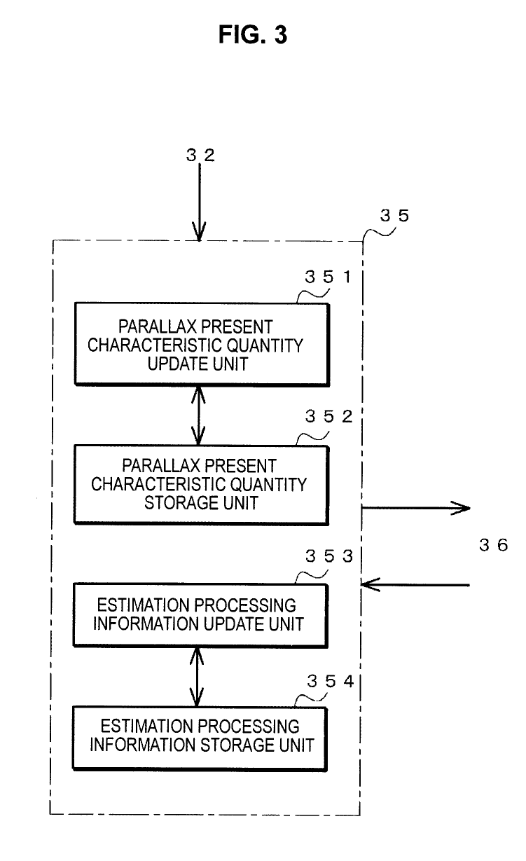

FIG. 3 shows the configuration of a characteristic quantity generation unit. The generation of a characteristic quantity used for generation of a reference picture list of a dependent view. The characteristic quantity generation unit 35 generates a characteristic quantity by using, for example, the average value of the SATD value in a picture when selected as the optimal mode of each block in the picture.

The characteristic quantity generation unit 35 generates reference pictures that are different in the time direction from pictures in a dependent view and the characteristic quantity showing a picture correlation for each candidate of the reference picture by setting reference pictures of the base view as candidates and outputs generated characteristic quantities to the reference picture list generation unit 36. The characteristic quantity generation unit 35 generates estimation processing information to estimate a characteristic quantity and outputs the estimation processing information to the reference picture list generation unit 36. Further, the characteristic quantity generation unit 35 updates stored characteristic quantities and estimation processing information based on a reference picture list generated by the reference picture list generation unit 36.

The characteristic quantity generation unit 35 includes a parallax present characteristic quantity update unit 351, a parallax present characteristic quantity storage unit 352, an estimation processing information update unit 353, and an estimation processing information storage unit 354.

When time predictions and parallax predictions are made, the parallax present characteristic quantity update unit 351 stores a characteristic quantity for a case where reference pictures in the parallax direction are used for motion prediction in the parallax present characteristic quantity storage unit 352 as a parallax present characteristic quantity SATDiv. Then, the parallax present characteristic quantity update unit 351 updates the parallax present characteristic quantity SATDiv stored in the parallax present characteristic quantity storage unit 352 each time the parallax present characteristic quantity SATDiv is calculated. Further, if the parallax present characteristic quantity SATDiv is never updated in a predetermined period, for example one or a plurality of GOP periods, as will be described later, the parallax present characteristic quantity update unit 351 updates the parallax present characteristic quantity SATDiv for each picture type. The parallax present characteristic quantity update unit 351 outputs the updated parallax present characteristic quantity SATDiv to the reference picture list generation unit 36. Thus, the parallax present characteristic quantity update unit 351 prevents the parallax present characteristic quantity SATDiv from becoming an uncorrelated characteristic quantity without being updated by updating the parallax present characteristic quantity SATDiv.

The estimation processing information update unit 353 calculates estimation processing information Psc used to estimate a characteristic quantity for a case where only time predictions are made and causes the estimation processing information storage unit 354 to store the estimation processing information Psc. Then, the estimation processing information update unit 353 updates the estimation processing information Psc stored in the estimation processing information storage unit 354. When the dependent view contains only time predictions, as shown in Formula (1), the estimation processing information update unit 353 calculates the ratio of a characteristic quantity SATDdv of the dependent view and a characteristic quantity SATDbv of the base view to set the ratio as the estimation processing information Psc. If time predictions and parallax predictions are used, the calculated estimation processing information Psc(n−1) is used. This is because it is experimentally revealed that the estimation processing information Psc takes similar values (highly correlated) even for images at different times if the temporal distance therebetween is close.

$$Psc ( n ) = \{ \begin{matrix}Psc ( n - 1 ) & ∵ Parallax predictions are present \\ \frac{SATDdv ( n )}{SATDbv ( n )} & ∵ Time predictions only\end{matrix} \} \qquad ( 1 )$$

Further, if a state in which parallax predictions are contained continues, the estimation processing information update unit 353 does not update the estimation processing information Psc and thus, the correlation of the estimation processing information Psc becomes lower with an increasing temporal distance. Therefore, if a state in which reference pictures in the parallax direction are contained in a reference picture list continues for a predetermined period, the estimation processing information Psc is caused to be updated by forcing the reference picture list to contain only reference pictures in the time direction by a time direction forced encoding determination unit 362 described later.

The estimation processing information update unit 353 updates the estimation processing information Psc in this manner and calculates an estimated characteristic quantity SATDtm, which is an estimated characteristic quantity by assuming that only time predictions are made, based on Formula (2) by using the updated estimation processing information Psc, and outputs the estimated characteristic quantity SATDtm to the reference picture list generation unit 36.

SATDtm=Psc×SATDbv (2)

Incidentally, the parallax present characteristic quantity update unit 351 and the estimation processing information update unit 353 may make updates by considering past information. For example, as shown in Formulas (3) and (4), a parallax present characteristic quantity SATDiv(n)′ or estimation processing information Psc(n)′ after the update can be calculated by making updates in consideration of pat information by an IIR filter. However, a case where the parallax present characteristic quantity is never updated in units of GOP and a case where estimation processing information is never updated in a plurality of GOP periods are excluded. “k1, k2” are coefficients.

SATDiv(n)′=k1×SATDiv(n−1)+(1−k1)×SATDiv(n) (3)

Psc(n)′=k2×Psc(n−1)+(1−k2)×Psc(n) (4)

### 4. Configuration and Operation of Reference Picture List Generation Unit

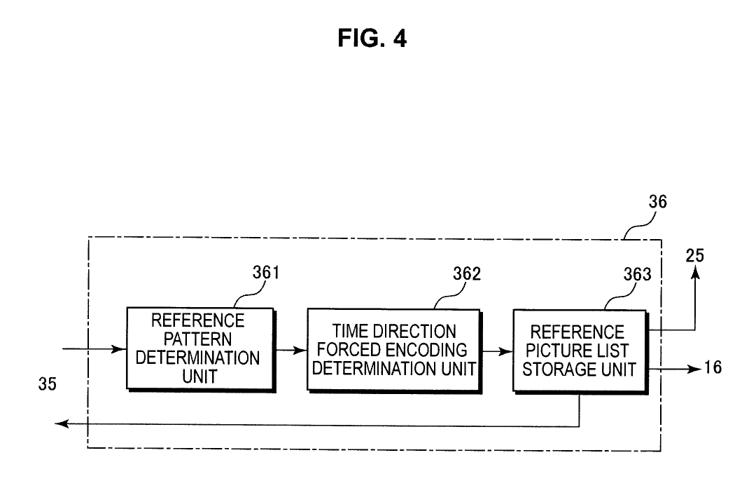

FIG. 4 shows the configuration of a reference picture list generation unit. The reference picture list generation unit 36 includes a reference pattern determination unit 361, a time direction forced encoding determination unit 362, and a reference picture list storage unit 363.

The reference pattern determination unit 361 determines whether to include reference pictures in the parallax direction in the reference picture list. The reference pattern determination unit 361 sets a reference pattern as a pattern including reference pictures in the parallax direction because, as will be described later, only a parallax prediction is made in the GOP starting picture.

If the dependent view is a progressive material, the reference pattern determination unit 361 determines the reference pattern of the next picture at the head of GOP based on a comparison result of a determinant value based on a characteristic quantity of the GOP starting picture and a threshold.

If, for example, like Formula (5), a determinant value (1/SATDdv) based on the characteristic quantity SATDdv of the first picture is larger than a threshold TH0, the reference pattern determination unit 361 sets the reference pattern of the next P picture or B picture as a pattern including reference pictures in the parallax direction. If the determinant value is equal to or less than the threshold TH0, the reference pattern determination unit 361 sets the reference pattern as a pattern of only reference pictures in the time direction.

(1/SATDdv)>TH0 (5)

In the case of an interlaced material, the reference pattern determination unit 361 sets the reference pattern as a pattern including reference pictures in the parallax direction because, as will be described later, a time prediction and a parallax prediction are typically made in the next picture at the head of GOP of a dependent view, that is, the first picture in the next field of the GOP. Further, the reference pattern determination unit 361 determines the reference pattern of each picture type in the dependent view based on a comparison result of the characteristic quantity SATDdv of the picture in the dependent view and the characteristic quantity SATDbv of the base view.

If, for example, as shown in Formula (6), a determinant value (SATDbv/SATDdv) indicating the ratio of the characteristic quantity SATDbv to the characteristic quantity SATDdv is larger than a threshold TH1, the reference pattern determination unit 361 sets the reference pattern as a pattern including reference pictures in the parallax direction. If the determinant value is equal to or less than the threshold TH1, the reference pattern determination unit 361 sets the reference pattern as a pattern of only reference pictures in the time direction.

SATDbv/SATDdv>TH1 (6)

The reference pattern determination unit 361 can also determine the reference pattern by using a difference between the characteristic quantity SATDdv of the dependent view and the characteristic quantity SATDbv of the base view as the determinant value. If, for example, as shown in Formula (7), a determinant value (SATDbv-SATDdv) is larger than a threshold TH2, the reference pattern determination unit 361 sets the reference pattern as a pattern including reference pictures in the parallax direction. If the determinant value is equal to or less than the threshold TH2, the reference pattern determination unit 361 sets the reference pattern as a pattern of only reference pictures in the time direction.

(SATDbv−SATDdv)>TH2 (7)

If the reference pattern is a pattern including reference pictures in the parallax direction in subsequent pictures, as shown in Formula (8), the reference pattern determination unit 361 compares the ratio of the estimated characteristic quantity SATDtm to the parallax present characteristic quantity SATDiv with a threshold TH3. The reference pattern determination unit 361 determines the reference pattern based on the comparison result.

SATDtm/SATDiv≦TH3 (8)

If the ratio of the estimated characteristic quantity SATDtm to the parallax present characteristic quantity SATDiv is equal to or less than a threshold TI13, the reference pattern determination unit 361 sets the reference pattern of the current picture type as a pattern of only reference pictures in the time direction. If the ratio is larger than the threshold TH3, the reference pattern determination unit 361 maintains the pattern including reference pictures in the parallax direction.

If the reference pattern is a pattern of only reference pictures in the time direction in subsequent pictures, as shown in Formula (9), the reference pattern determination unit 361 compares the ratio of the characteristic quantity SATDdv to a parallax present characteristic quantity SATDive immediately before with a threshold TH4. The reference pattern determination unit 361 determines the reference pattern based on the comparison result.

SATDdv/SATDive>TH4 (9)

If the ratio of the characteristic quantity SATDdv of the dependent view to the parallax present characteristic quantity SATDive immediately before is larger than the threshold TH4, the reference pattern determination unit 361 sets the reference pattern of the current picture type as a pattern including reference pictures in the parallax direction. If the ratio is equal to or less than threshold TH4, the reference pattern determination unit 361 maintains the pattern including reference pictures in the time direction.

The parallax present characteristic quantity immediately before is, if the parallax present characteristic quantity is updated for each picture, the parallax present characteristic quantity updated last. If the parallax present characteristic quantity is updated for each picture type, the parallax present characteristic quantity immediately before is the parallax present characteristic quantity updated last of the same picture type. Similarly, the estimation processing information Psc may be one updated for each picture or each picture type.

The determination may be made not only based on the ratio like Formulas (8) and (9), but also by setting a difference between the estimated characteristic quantity SATDtm and the parallax present characteristic quantity SATDiv or a difference between the characteristic quantity SATDdv of the dependent view and the parallax present characteristic quantity SATDive immediately before as the determinant value. That is, the reference pattern is determined based on the comparison result of characteristic quantities.

Further, as another determination method of the reference pattern, the reference pattern determination unit 361 may update the pattern of reference pictures or maintain the pattern of the reference picture immediately before based on the comparison result between the determinant value based on the characteristic quantity obtained for the first picture of the dependent view and the threshold.

For example, reference pictures in the time direction are not to be used for the GOP starting picture, that is, the first picture of the top field, and thus, the reference pictures will all be reference pictures in the parallax direction. Next, the determinant value (SATDbv/SATDdv) indicating the ratio of the characteristic quantity SATDbv to the characteristic quantity SATDdv is larger than a threshold for the first picture in the next field of the GOP starting picture, that is, the first picture in the bottom field of the GOP, the reference pattern determination unit 361 sets the reference pattern as a pattern including reference pictures in the parallax direction. If the determinant value is smaller than the threshold, the reference pattern determination unit 361 determines the pattern for each picture type.

If the pattern of the reference pictures immediately before is a pattern including reference pictures in the parallax direction in the determination of pattern for each picture type, the reference pattern determination unit 361 compares the ratio (SATDtm/SATDiv) of the estimated characteristic quantity SATDtm to the parallax present characteristic quantity SATDiv with a threshold and sets the reference pattern of the current picture type to a pattern including only reference pictures in the time direction if the ratio is equal to or less than the threshold. If the ratio is larger than the threshold, the reference pattern determination unit 361 maintains the pattern of the reference pictures immediately before.

If the pattern of the reference pictures immediately before is a pattern of only reference pictures in the time direction in the determination of pattern for each picture type, the reference pattern determination unit 361 compares the ratio (SATDdv/SATDive) of the characteristic quantity SATDdv to the parallax present characteristic quantity SATDive immediately before with a threshold and sets the reference pattern of the current picture type to a pattern including reference pictures in the parallax direction if the ratio larger than the threshold. If the ratio is equal to or less than the threshold, the reference pattern determination unit 361 maintains the pattern of the reference pictures immediately before. In this manner, the reference pattern may be determined.

Further, if a determination is made for each scene, a characteristic quantity SATD of only time predictions of the whole scene and a characteristic quantity SATD with parallax are added up and normalized for each picture and the two SATD are compared to decide a reference picture list pattern. Alternatively, a reference pattern of the whole scene may be determined by compared SATD of pictures for which a parallax prediction can typically be used such as the scene change first picture and SATD of the base view. Further, the GOP unit can be determined in the same manner.

The time direction forced encoding determination unit 362 performs processing to set a predetermined picture as a pattern that makes only time predictions regardless of the determination result of the reference pattern determination unit 361. The time direction forced encoding determination unit 362 specifies the last picture of a plurality of GOP periods as a picture to set so that only time predictions are forcibly made. If a determination is made for each picture type, the last picture of a plurality of GOP periods may be set to make a time prediction or the last picture of a plurality of GOP periods may be set to make a time prediction for each picture type.

The reference picture list storage unit 363 stores a reference pattern determined by the reference pattern determination unit 361 and a reference picture list based on a reference pattern forcibly set by the time direction forced encoding determination unit 362.

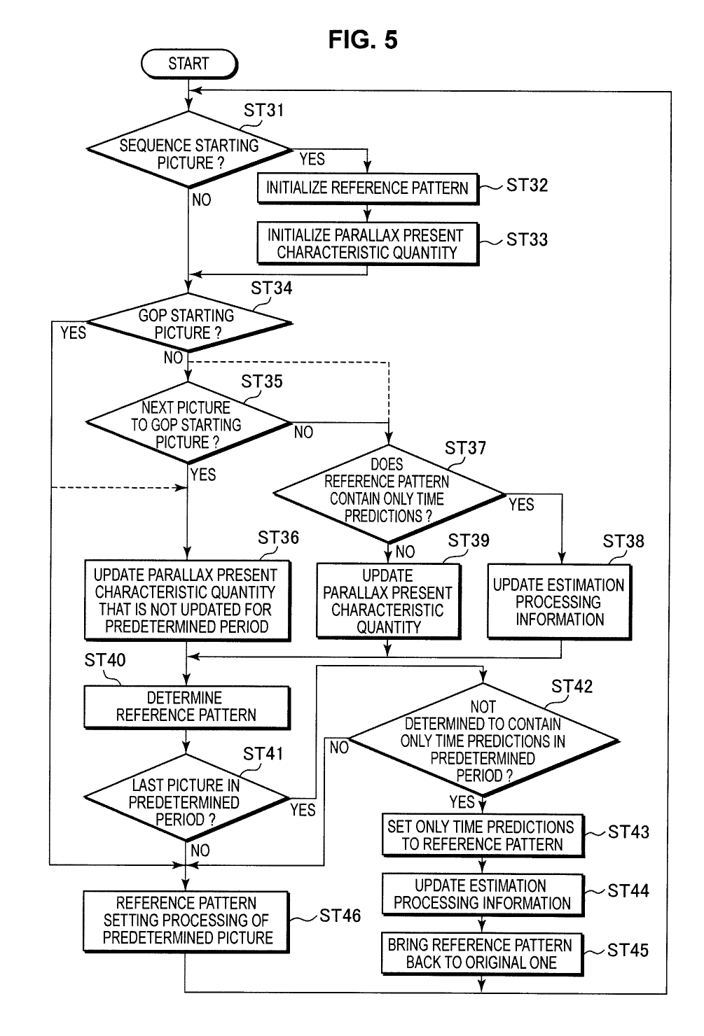

FIG. 5 is a flow chart showing an operation of the characteristic quantity generation unit and the reference picture list generation unit. In step ST31, the image encoding apparatus 10 determines whether the picture is the sequence starting picture. If the picture is the sequence starting picture, the reference picture generation unit 36 of the image encoding apparatus 10 proceeds to step ST32 and if the picture is not the sequence starting picture, the reference picture list generation unit 36 proceeds to step ST34.

In step ST32, the image encoding apparatus 10 initializes the reference pattern. The reference picture list generation unit 36 initializes the reference pattern to a pattern of only reference pictures in the time direction before proceeding to step ST33.

In step ST33, the image encoding apparatus 10 initializes the parallax present characteristic quantity. The characteristic quantity generation unit 35 of the image encoding apparatus 10 sets a parallax present characteristic quantity SAID-iv as the initial value before returning to step ST31.

In step ST34, the image encoding apparatus 10 determines whether the picture is the GOP starting picture. If the picture is an interlaced material, the image encoding apparatus 10 proceeds to step ST46 if the picture is at the head of GOP and proceeds to step ST35 if the picture is not at the head of GOP. If the picture is a progressive material, the image encoding apparatus 10 proceeds to step ST36 as indicated by a broken line if the picture is at the head of GOP and proceeds to step ST37 as indicated by a broken line if the picture is not at the head of GOP. If the picture is a progressive material, the picture at the head of GOP typically contains a reference picture in the parallax direction, but unless there are at least two reference pictures that can be referred to, the next picture to the picture at the head of GOP is not typically encoded by a pattern containing a reference picture in the parallax direction. That is, if the number of reference pictures is 1. processing in step ST36 described later may not be performed correctly when encoded by only reference pictures in the time direction, but the picture at the head of GOP is typically encoded by a pattern containing a reference picture in the parallax direction and so the processing in step ST36 can be performed correctly.

In step ST35, the image encoding apparatus 10 determines whether the picture is the next picture to the picture at the head of GOP. The image encoding apparatus 10 proceeds to step ST36 if the picture is the next picture to the picture at the head of GOP and proceeds to step ST37 if the picture is not the next picture to the picture at the head of GOP.

In step ST36, the image encoding apparatus 10 updates parallax present characteristic quantities that have not been updated for a predetermined period. If no update is made for a long period, the correlation of the parallax present characteristic quantity SATDiv becomes lower. If the picture is an interlaced material, as will be described later, the reference pattern becomes a pattern containing a reference picture in the parallax direction for the next picture to the picture at the head of GOP. Therefore, the characteristic quantity generation unit 35 updates the parallax present characteristic quantity SATDiv of picture types that are never updated for a predetermined period, for example, in the GOP immediately before by using a characteristic quantity of the next picture to the picture at the head of GOP before proceeding to step ST46.

In step ST37, the image encoding apparatus 10 determines whether the reference pattern contains only time predictions. The reference picture list generation unit 36 determines whether the reference pattern contains only time predictions, proceeds to step ST38 if the reference pattern is a pattern of only reference pictures in the time direction, and proceeds to step ST39 if the reference pattern is a pattern containing a reference picture in the parallax direction.

In step ST38, the image encoding apparatus 10 updates estimation processing information. The characteristic quantity generation unit 35 updates the estimation processing information Psc by using the characteristic quantity SATDbv of the base view and the characteristic quantity SATDdv of the dependent view before proceeding to step ST40.

In step ST39, the image encoding apparatus 10 updates the parallax present characteristic quantity SATDiv. The characteristic quantity generation unit 35 updates the parallax present characteristic quantity SATDiv by using the characteristic quantity SATDdv of the dependent view because the reference pattern is a pattern containing a reference picture in the parallax direction before proceeding to step ST40.

In step ST40, the image encoding apparatus 10 determines the reference pattern. If the reference pattern of the picture is a pattern containing a reference picture in the parallax direction, the reference picture list generation unit 36 compares the determinant value based on the parallax present characteristic quantity SATDiv and the estimated characteristic quantity SATDtm with a threshold and determines the reference pattern of the next picture based on the comparison result. If the reference pattern of the picture is a pattern of only reference pictures in the time direction, the reference picture list generation unit 36 compares the determinant value based on the parallax present characteristic quantity SATDive immediately before and the characteristic quantity SATDdv of the dependent view with a threshold. The reference picture list generation unit 36 determines the reference pattern of the next picture based on the comparison result. In this manner, the reference picture list generation unit 36 compares characteristic quantities in accordance with reference patterns of the picture and proceeds to step ST41 after determining the reference pattern of the next picture based on the comparison result.

In step ST41, the image encoding apparatus 10 determines whether the picture is the last picture in the predetermined period. The reference picture list generation unit 36 proceeds to step ST42 if the picture is the last picture in the predetermined period, for example, a plurality of GOP and proceeds to step ST46 if the picture is not the last picture.

In step ST42, the image encoding apparatus 10 determines whether the reference pattern is determined to contain only time predictions in the predetermined period. The reference picture list generation unit 36 proceeds to step ST43 if the reference pattern is never determined to be a pattern of only reference pictures in the time direction in the predetermined period, for example, a plurality of GOPs. The reference picture list generation unit 36 proceeds to step ST46 if the reference pattern is determined to be a pattern of only reference pictures in the time direction at least once.

In step ST43, the image encoding apparatus 10 sets the reference pattern to only time predictions. The reference picture list generation unit 36 forcibly sets the reference pattern to a pattern of only reference pictures in the time direction before proceeding to step ST44.

In step ST44, the image encoding apparatus 10 updates the estimation processing information Psc. The reference pattern is forcibly set to a pattern of only reference pictures in the time direction and so the characteristic quantity generation unit 35 updates the estimation processing information Psc of picture types that are never updated in the predetermined period, for example, a plurality of GOP before proceeding to step ST45.

In step ST45, the image encoding apparatus 10 brings the reference pattern back to the original one. The reference picture list generation unit 36 brings the reference pattern back to the reference pattern decided before the reference pattern being forcibly encoded only by reference pictures in the time direction to return to step ST31 before determining the next picture.

In step ST46, the image encoding apparatus 10 performs reference pattern setting processing of a predetermined picture. If the picture is a progressive material, the reference picture list generation unit 36 sets the reference pattern of the picture at the head of GOP, which is, as will be described later, an anchor picture, to a pattern with a parallax. Further, the reference pattern determination unit 361 discriminates the reference pattern of the next picture to the picture at the head of GOP based on the comparison result of the determinant value based on a characteristic quantity of the picture at the head of GOP and the threshold. If, for example, the determinant value (1/SATDdv) based on the characteristic quantity SATDdv of the first picture is equal to or less than the threshold TH0, the reference pattern determination unit 361 sets the reference pattern of the next picture to a pattern of only reference pictures in the time direction. If the determinant value larger than the threshold, the reference pattern determination unit 361 sets the reference pattern of the next picture to a pattern containing a reference picture in the parallax direction before returning to step ST31.

If the reference pattern is a pattern including reference pictures in the parallax direction in the determination of reference pattern for each picture type, the reference pattern determination unit 361 determines the reference pattern of the current picture type to be a pattern of only a reference picture in the time direction or the pattern immediately before containing a reference picture in the parallax direction based on, as described above, the comparison result of the determinant value (SATDtm/SATDiv) and the threshold TH3. If the reference pattern is a pattern of only reference pictures in the time direction, the reference pattern determination unit 361 determines the reference pattern to be a pattern containing a reference picture in the parallax direction or the pattern immediately before of only reference pictures in the time direction based on, as described above, the comparison result of the determinant value (SATDdv/SATDive) and the threshold TH4.

If the picture is an interlaced material, the reference picture list generation unit 36 sets the reference pattern of the picture at the head of GOP and the next picture (in a field different from the picture at the head of GOP) to a pattern including reference pictures in the parallax direction because, as will be described later, the picture at the head of GOP is an anchor picture. Further, the reference pattern determination unit 361 compares the characteristic quantity SATDdv calculated for the next picture to the picture at the head of GOP, that is, the first picture in the next field of the GOP and the characteristic quantity SATDbv of the base view. The reference pattern determination unit 361 discriminates the reference pattern of the next picture type in the dependent view based on the comparison result. That is, the reference pattern determination unit 361 discriminates the reference pattern of the next picture type in the dependent view based on the comparison result of the determinant value based on the characteristic quantity SATDdv and the characteristic quantity SATDbv and the threshold before returning to step ST31.

In this manner, the reference picture list generation unit 36 determines the reference pattern of each picture of the dependent view to generate a reference picture list based on the determination result. Other methods may also be used for the determination of the reference pattern.

In the reference picture list, for example, a reference index of a shorter code length is allocated to a smaller characteristic quantity SATD. As another method of allocating the reference index, a method of using the ratio of reference index can be considered. That is, if the reference pattern of the next picture contains a reference picture in the parallax direction, reference pictures with a larger ratio of the reference index selected during inter-prediction of reference pictures in the time direction and the parallax direction are allocated to the reference index of a short code length of the reference list of the next picture. If the reference pattern of the next picture contains only reference pictures in the time direction, reference pictures with a larger ratio of the reference index selected during inter-prediction of reference pictures in the time direction are allocated to the reference index of a short code length of the reference list of the next picture. Thus, the reference index can be allocated by using the ratio of reference index.

### 5. Operation when Progressive Material is Used

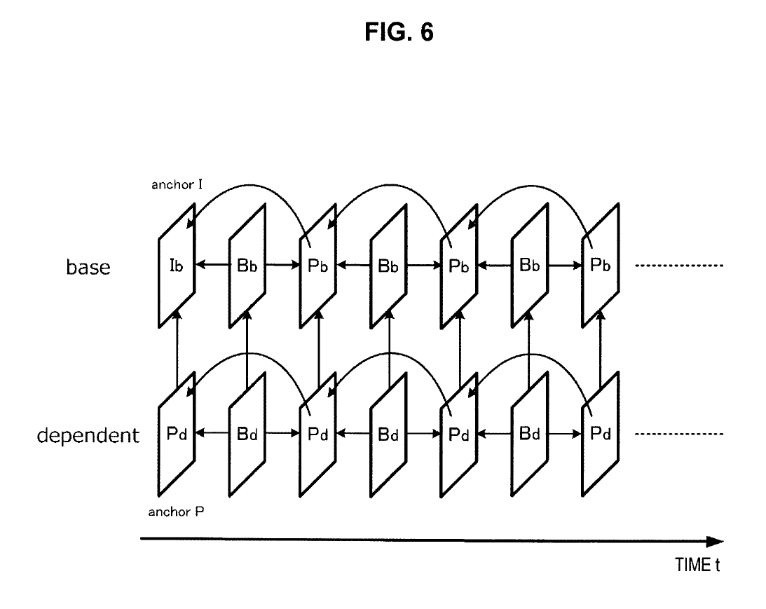

Next, the operation when a progressive material is used will be described more concretely. FIG. 6 shows a general reference relationship between a base view and a dependent view. The number of reference pictures of the dependent view is larger than the number of reference pictures of the base view in the case of the reference relationship shown in FIG. 6 because pictures in the base view direction can be referred to. More specifically, the number of reference pictures of a P picture in the base view is 1.

The number of reference pictures of a B picture is 2, the number of reference pictures of the P picture in the dependent view is 2, and the number of reference pictures of the B picture is 3. Incidentally, the first picture is an anchor picture.

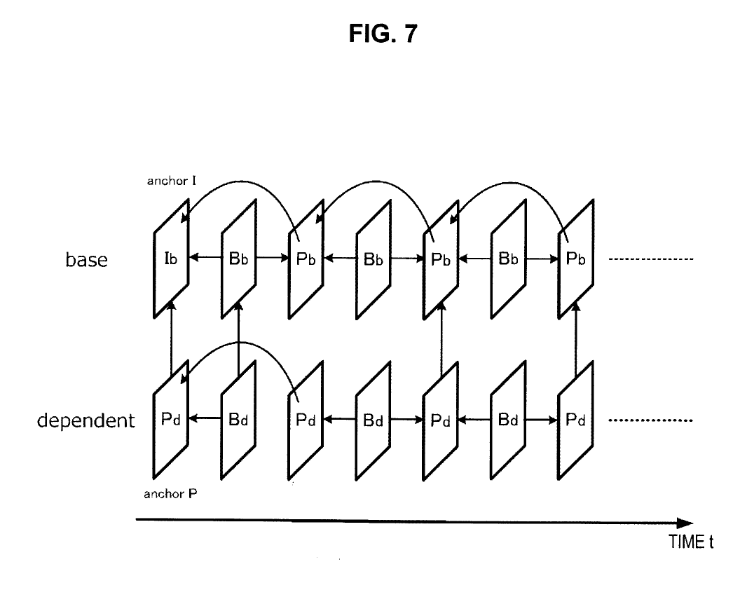

FIG. 7 illustrates the reference relationship when the base view and the dependent view are made to have an equal number of reference pictures. More specifically, it is assumed that the number of reference pictures of the P picture in the base view is 1, the number of reference pictures of the B picture is 2, the number of reference pictures of the P picture in the dependent view is 1, and the number of reference pictures of the B picture is 2. As is evident from FIG. 7, it is necessary to delete the reference picture in the time direction or the parallax direction.

Next, the generation operation of a reference picture list when the base view and the dependent view are made to have an equal number of reference pictures will be described.

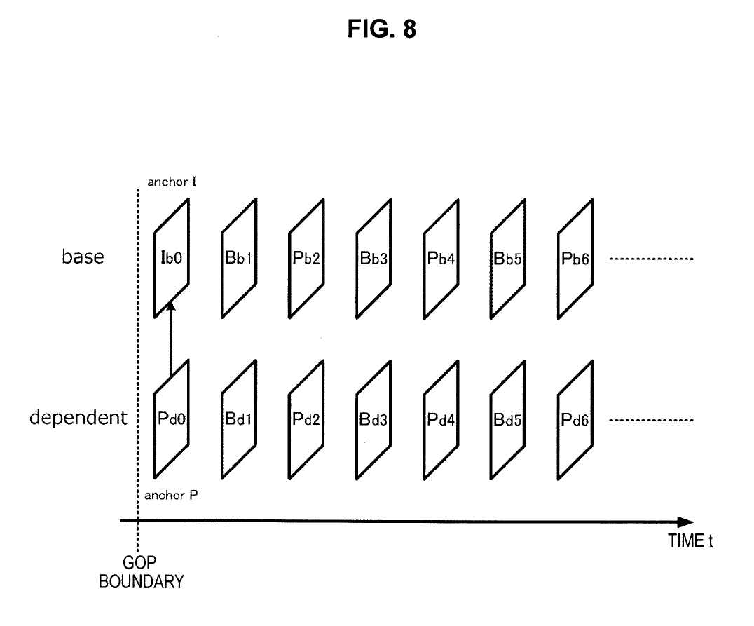

FIG. 8 shows the reference relationship of the first picture. First pictures of the GOP in the base view and the dependent view are anchor pictures (anchor I, anchor P). Thus, the reference picture list generation unit 36 sets only the I picture (Ib0) of the base view as a reference picture for the P picture (Pd0) at the head of the dependent view.

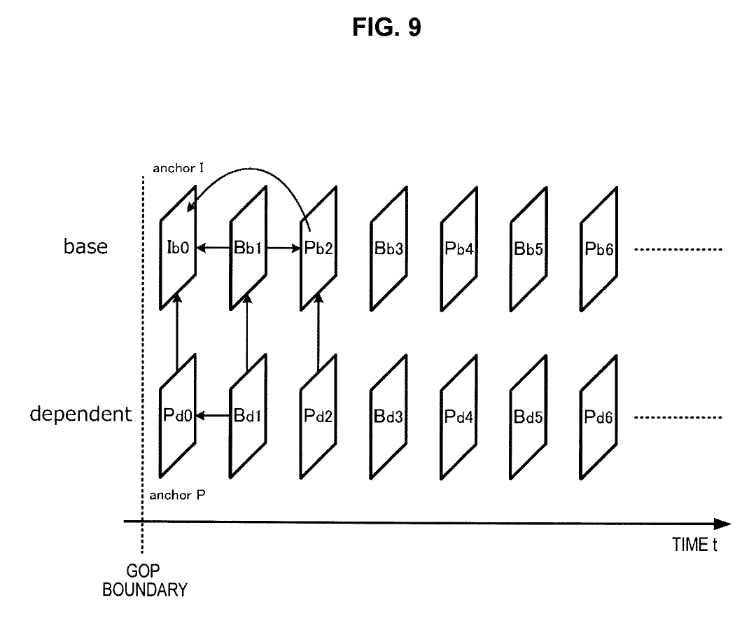

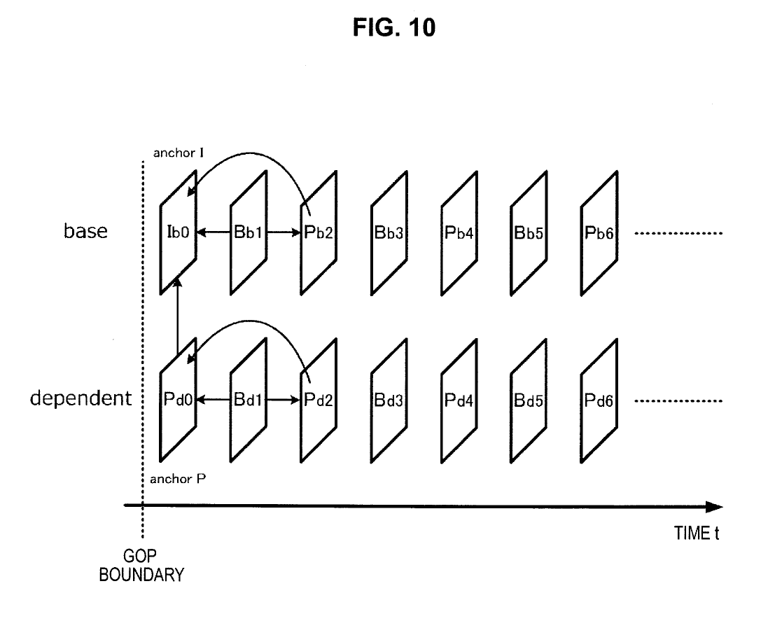

FIG. 9 shows a case where a discriminant value is larger than a threshold in processing of the dependent view and FIG. 10 shows a case where the discriminant value is equal to or less than the threshold. If the determinant value (1/SATDdv) is larger than the threshold, as shown in FIG. 9, the reference picture list generation unit 36 sets the reference pattern of the second or subsequent B picture (Bd1) or P picture (Pd2) of the dependent view as a pattern including a reference picture in the parallax direction. If the characteristic quantity (1/SATDdv) is larger than the threshold, as described above, the reference pattern is set as a pattern including a reference picture in the parallax direction. If the determinant value (1/SATDdv) is equal to or less than the threshold, as shown in FIG. 10, the reference picture list generation unit 36 sets the reference pattern of the second or subsequent B picture (Bd1) or P picture (Pd2) of the dependent view as a pattern of only reference pictures in the time direction.

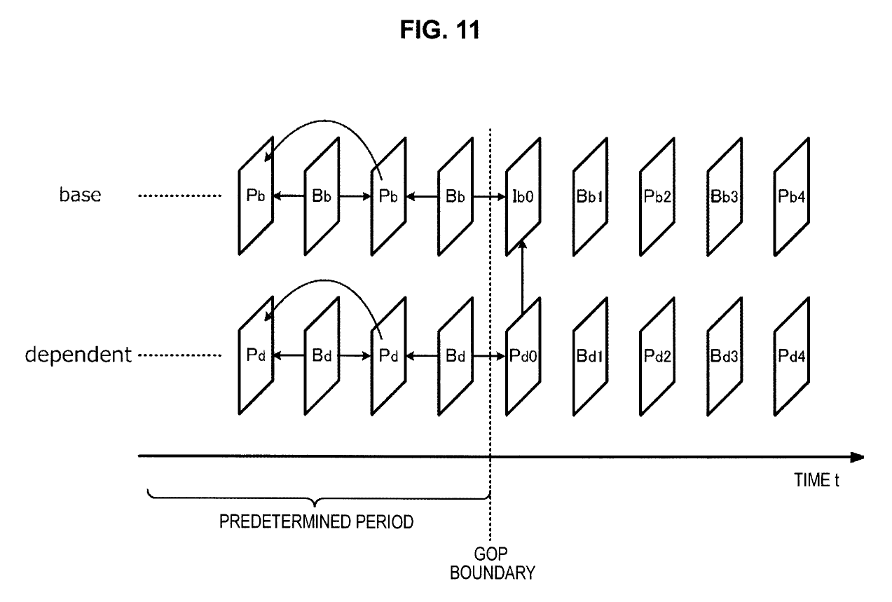

If, as shown in FIG. 11, the reference pattern is never set as a pattern including a reference picture in the parallax direction in the predetermined period immediately before, the characteristic quantity generation unit 35 sets the characteristic quantity SATDdv of the picture as the parallax present characteristic quantity SATDiv. If, for example, the reference pattern is never set as a pattern including a reference picture in the parallax direction except the anchor picture in the dependent view in the period of one GOP immediately before, the characteristic quantity generation unit 35 stores the characteristic quantity determined for the anchor picture in the dependent view of the GOP, that is, the characteristic quantity SATDdv determined for the P picture (Pd0) as the parallax present characteristic quantity SATDiv of the subsequent pictures for each picture type.

If the current P picture contains only time predictions, the reference picture list generation unit 36 decides the reference picture for the next P picture based on the comparison result of comparing the stored parallax present characteristic quantity SA/Dive immediately before and the characteristic quantity SATDdv calculated for the current P picture.

For comparison of characteristic quantities, a difference or ratio of two characteristic quantities is set as a determinant value and the determinant value is compared with a threshold. If the determinant value (SATDdv-SATDive) is larger than the threshold THa or the determinant value (SATDdv/SATDive) is larger than the threshold THb, the reference picture list generation unit 36 sets the reference pattern of the next P picture as a pattern including a reference picture in the parallax direction or maintains the pattern immediately before. If the determinant value is equal to or less than the threshold THa, THb, the reference picture list generation unit 36 sets the reference pattern of the next P picture as a pattern including only reference pictures in the time direction.

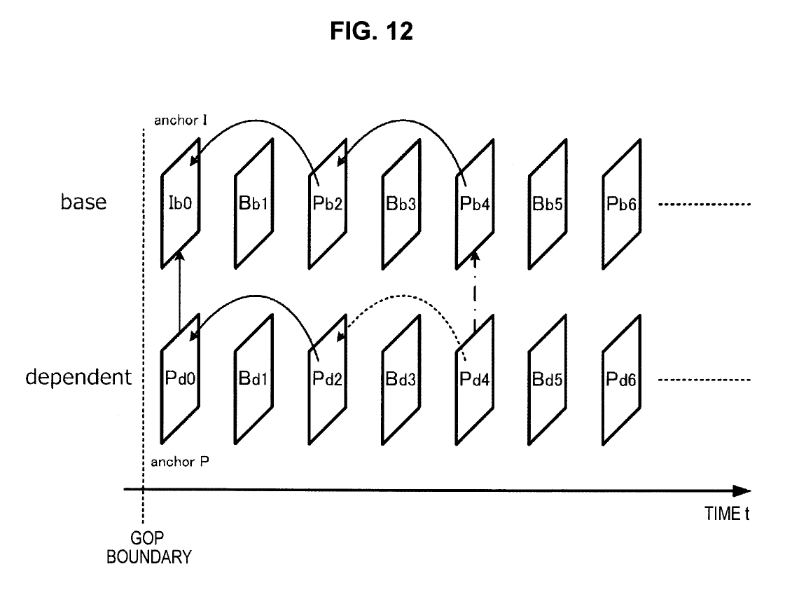

FIG. 12 shows a case where the current picture contains only time predictions. It for example, the reference pattern of the current P picture (Pd2) is a pattern of only a reference picture in the time direction, the reference picture list generation unit 36 compares the stored parallax present characteristic quantity SATDive immediately before and the characteristic quantity SATDdv calculated for the P picture (Pd2). If the determinant value (SATDdv-SATDive) is larger than the threshold THa, the reference picture list generation unit 36 sets the reference pattern of the next P picture (Pd4) of the P picture (Pd2) as a pattern containing, as indicated by an arrow of an alternate long and short dash line, a reference picture in the parallax direction. If the determinant value (SATDdv/SATDive) is larger than the threshold THb, the reference picture list generation unit 36 sets in the same manner. Further, if the determinant value is equal to or less than the threshold, the reference picture list generation unit 36 sets the reference pattern of the next P picture (Pd4) as a pattern of, as indicated by an arrow of a dotted line, only reference pictures in the time direction.

The characteristic quantity generation unit 35 calculates the estimation processing information Psc (Psc=SATDdv/SATDbv) from characteristic quantities of the base view and the dependent view.

If the current P picture contains a parallax prediction, the characteristic quantity generation unit 35 calculates the estimated characteristic quantity SATDtm. The estimated characteristic quantity SATDtm is calculated by multiplying the characteristic quantity SATDbv of the base view by the estimation processing information Psc. Further, the reference picture list generation unit 36 compares the estimated characteristic quantity SATDtm and the parallax present characteristic quantity SATDiv to set the reference pattern based on the comparison result.

For comparison of characteristic quantities, as described above, a difference or ratio of two characteristic quantities is set as a determinant value and the determinant value is compared with a threshold. If the determinant value (SATDtm−SATDiv) is larger than the threshold THc or the determinant value (SATDtm/SATDiv) is larger than the threshold THd, the reference picture list generation unit 36 continues to set the reference pattern of the next P picture as a pattern containing a reference picture in the parallax direction. If determinant value is equal to or less than the threshold, the reference picture list generation unit 36 sets the reference pattern of the next P picture as a pattern of only reference pictures in the time direction.

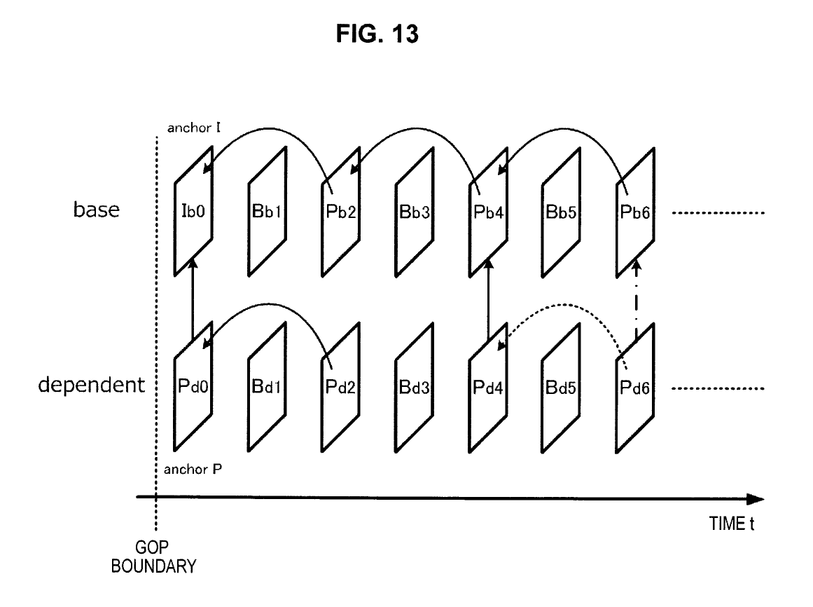

FIG. 13 is a diagram showing a case where the current picture contains a parallax prediction. If for example, the reference pattern of the current P picture (Pd4) is a pattern containing a reference picture in the parallax direction, the characteristic quantity generation unit 35 calculates the estimated characteristic quantity SATDtm by multiplying the characteristic quantity SATDbv of the P picture (Pb4) of the base view by the estimation processing information Psc. The reference picture list generation unit 36 compares the calculated estimated characteristic quantity SATDtm and the parallax present characteristic quantity SATDiv calculated for the P picture (Pd4). If the determinant value (SATDtm-SATDiv) is larger than the threshold THc, the reference picture list generation unit 36 continues to set the reference pattern of the next P picture (Pd6) as a pattern containing, as indicated by an arrow of an alternate long and short dash line, a reference pattern in the parallax direction. If the determinant value (SATDtm/SATDiv) is larger than the threshold THd, the reference picture list generation unit 36 sets in the same manner. Further, if the determinant value is equal to or less than the threshold, the reference picture list generation unit 36 sets the reference pattern of the next P picture (Pd6) as a pattern of, as indicated by an arrow of a dotted line, only reference pictures in the time direction. The reference picture list generation unit 36 also considers and stores a parallax present characteristic quantity SATD-iv calculated for the current P picture as the parallax present characteristic quantity of the next P picture.

The characteristic quantity generation unit 35 and the reference picture list generation unit 36 perform processing on B pictures in the same manner as P pictures. The reference picture list generation unit 36 determines whether to include a picture in the parallax direction in the reference picture as a reference pattern based on the comparison result between the determinant value based on a characteristic quantity of a case where a reference picture in the parallax direction is included, a characteristic quantity of a case where only reference pictures in the time direction is included and the threshold.

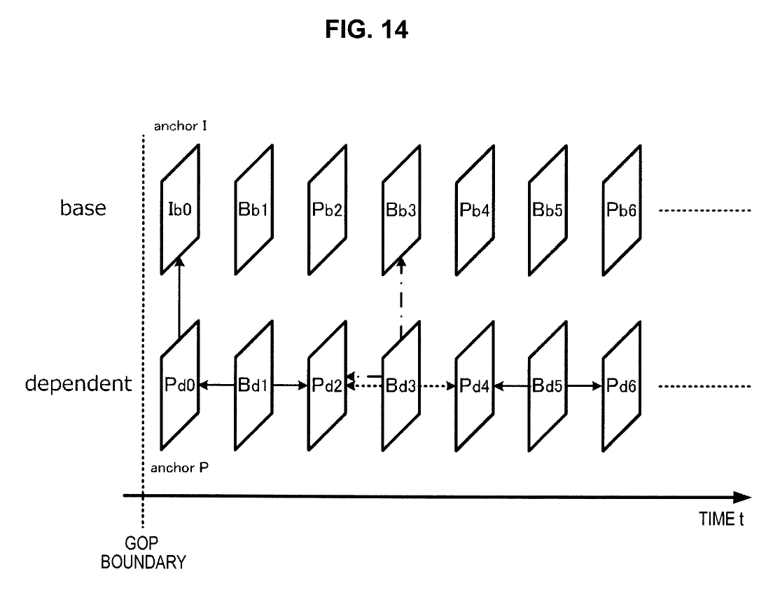

FIG. 14 shows a case where the current picture in the B picture contains only time predictions. If, for example, the reference pattern of the current B picture (Pd1) is a pattern of only reference pictures in the time direction, the reference picture list generation unit 36 decides the reference picture for the next B picture (Bd3) based on the comparison result of using and comparing the stored parallax present characteristic quantity SATDive immediately before and the characteristic quantity SATDdv of the current picture, that is, the B picture (Bd1).

For comparison of characteristic quantities, a difference or ratio of two characteristic quantities is set as a determinant value and the determinant value is compared with a threshold. If the determinant value (SATDdv−SATDive) is larger than a threshold THe, the reference picture list generation unit 36 sets the reference pattern of the next B picture (Bd3) as a pattern containing, as indicated by an arrow of an alternate long and short dash line, a reference picture in the parallax direction. If the determinant value (SATDdv/SATDive) is larger than a threshold Tiff, the reference picture list generation unit 36 sets in the same manner. Further, if the determinant value is equal to or less than the threshold, the reference picture list generation unit 36 sets the reference pattern of the next B picture (Bd3) as a pattern of, as indicated by an arrow of a dotted line, only reference pictures in the time direction.

Incidentally, the characteristic quantity SATDiv, which is a characteristic quantity for a case where a parallax prediction is contained, is updated at least once for the P picture at the head of GOP in the dependent view. However, if a pattern containing a reference picture in the parallax direction continues, the period in which the estimation processing information Psc is not updated will be longer because the characteristic quantity SATDdv in a reference pattern using a pattern of only a reference picture in the time direction is not calculated. The estimated characteristic quantity SATDtm is calculated, as described above, by multiplying the characteristic quantity SATDbv of the base view by the estimation processing information Psc and thus, reliability of the estimated characteristic quantity SATDtm becomes lower with an increasingly longer period in which the estimation processing information Psc is not updated. Therefore, there is a possibility that the reference picture list generation unit 36 may not be able to determine the reference pattern appropriately.

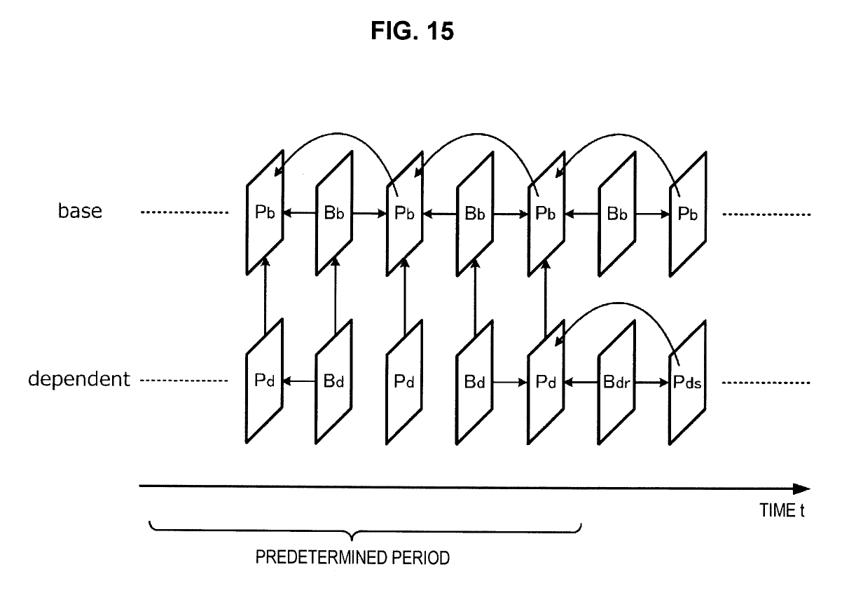

Thus, if the reference pattern is not set as a pattern of only reference pictures in the time direction in the predetermined period, for example, a period of several GOPs, the reference picture list generation unit 36 sets the reference pattern of the next picture as a pattern of only reference pictures in the time direction. By setting the reference pattern as a pattern of only reference pictures in the time direction in this manner, the characteristic quantity generation unit 35 can update the estimation processing information Psc. FIG. 15 shows a case where the estimation processing information Psc is updated by setting the reference pattern as a pattern of only reference pictures in the time direction. If, for example, the reference pattern containing a reference picture in the parallax direction continues for a predetermined period, the reference picture list generation unit 36 sets the reference pattern of the next B picture (Bdr) as a pattern of only reference pictures in the time direction. The reference picture list generation unit 36 also sets the reference pattern for the P picture (Pds) of different picture types as a pattern of only reference pictures in the time direction.

Thus, according to the present technology, as many reference pictures in the time direction or pictures including the parallax direction as pictures of the base view can be selected in the dependent view to increase encoding efficiency so that encoding efficiency can be improved more than in the base view. Moreover, because the base view and the dependent view have the same number of reference pictures, if an existing encoder is diverted to realize an MVC by alternately encoding the base view and the dependent view, the amount of processing can be made equivalent for the base view and the dependent view. If an MVC is realized by using two existing encoders, one to compress and encode the base view and the other to compress and encode the dependent view, the amount of processing can be made equivalent for the base view and the dependent view and thus, it is not necessary to use an encoder with higher processing capabilities for the dependent view.

### 6. Operation when Interlaced Material is Used

A case of the progressive material is described in the above embodiment and encoding efficiency can also be enhanced by performing similar processing on an interlaced material. It is assumed that an image is constituted of I pictures and P pictures to make the present technology easier to understand.

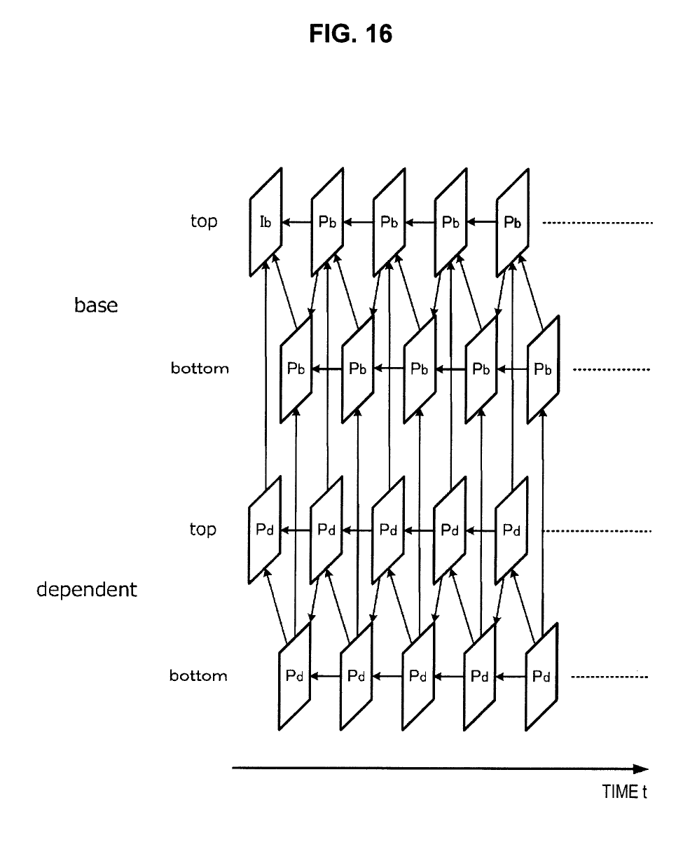

FIG. 16 is a diagram showing the reference relationship the base view and the dependent view are interlaced materials.

The I picture at the head of the top field in the base view is an anchor picture. The I picture is referred to by P pictures at the head of the bottom field of the base view and the top field of the dependent view and the next P picture of the top field in the base view.

The P picture at the head of the bottom field in the base view is the picture immediately alter the anchor picture and refers to I pictures of the top field. The picture is referred to by the P picture at the head of the bottom field in the dependent view and the next P pictures of the top field and the bottom field in the base view.

The P picture at the head of the top field in the dependent view is an anchor picture and refers to the I picture in the top field of the base view. The anchor picture is referred to by the P picture at the head in the bottom field of the dependent view and the next P picture of the top field in the dependent view.

The P picture at the head of the bottom field in the dependent view is the picture immediately after the anchor picture and refers to the P picture at the head of the top field in the dependent view. The picture is referred to by the next P pictures of the top field and the bottom field in the dependent view.

The second and subsequent P pictures have the picture immediately before in the opposite field as the reference picture. Further, for example, the picture in the same field of the base view is included in the dependent view.

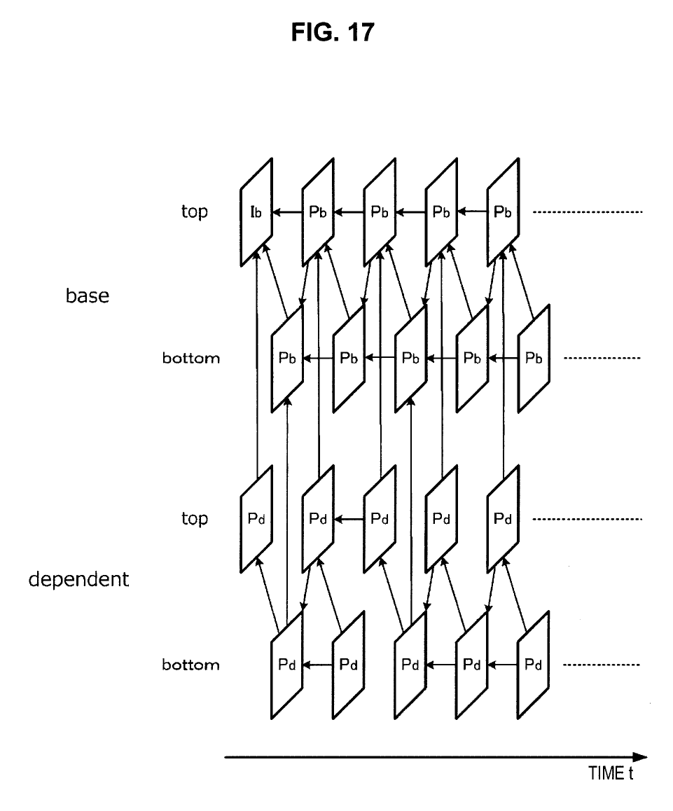

The second and subsequent pictures of each field in the base view each have two reference pictures. However, the second and subsequent pictures of each field in the dependent view each have three reference pictures. Therefore, as shown in FIG. 17, the reference picture list generation unit 36 sets the number of reference pictures of the second and subsequent pictures of each field in the dependent view to 2 to equalize the number of reference pictures in the base view and the dependent view. The reference picture list generation unit 36 also determines whether to include a reference picture in the parallax direction in the reference pattern so that encoding efficiency is improved when setting the number of reference pictures of the second and subsequent pictures of each field in the dependent view to 2.

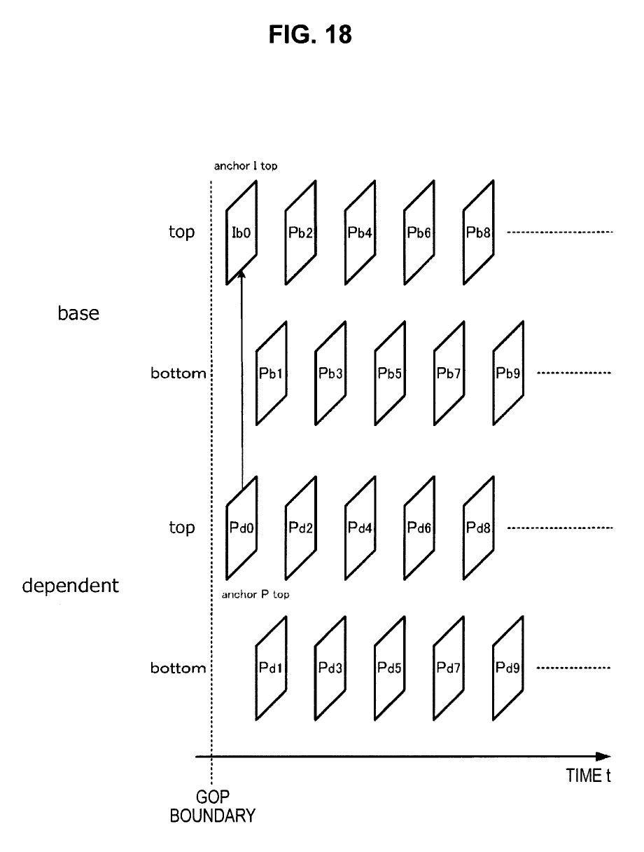

FIG. 18 shows the reference relationship of the first picture of the top field in the dependent view. The first pictures (Ib0, Pd0) of the top field in the base view and the dependent view are anchor pictures. The P picture (Pd0) at the head of the top field in the dependent view has only the I picture (Ib0) of the top field in the base view as a reference picture.

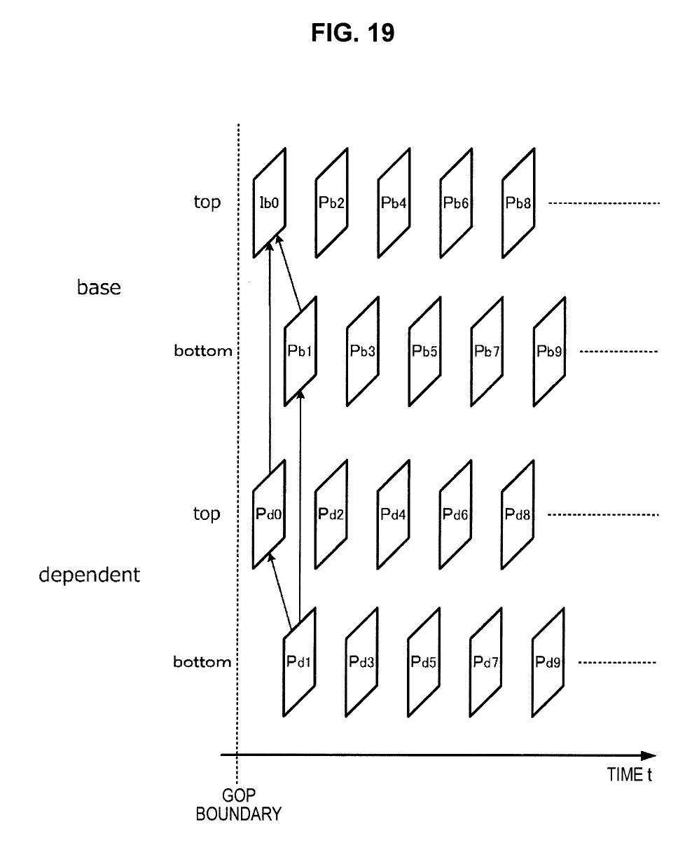

FIG. 19 shows the reference relationship of the first picture of the bottom field in the dependent view. The P picture (Pd1) at the head of the bottom field in the dependent view has the P picture (Pb1) of the bottom field in the base view and the P picture (Pd0) of the top field in the dependent view as reference pictures.

Next, the reference picture list generation unit 36 compares the characteristic quantity SATDdv of the next picture to the picture at the head of GOP of the dependent view, that is, the P picture (Pd1) at the head of the bottom field and the characteristic quantity SATDbv of the P picture (Pb1) at the head of the bottom field in the base view to determine the reference pattern of the next P picture (Pd2).

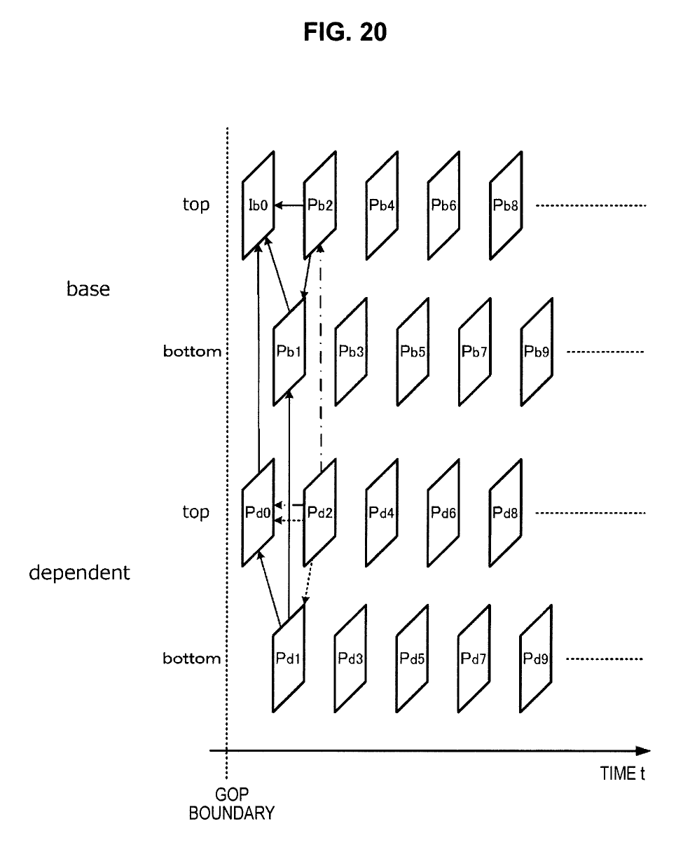

FIG. 20 shows processing of the first picture of the bottom field in the dependent view. If the determinant value (SATDbv-SATDdv) is larger than a threshold THg, the reference picture list generation unit 36 sets the reference pattern of the next P picture (Pd2) of the P picture (Pd 1) as a pattern containing, as indicated by an arrow of an alternate long and short dash line, a reference picture in the parallax direction. If the determinant value (SATDbv/SATDdv) is larger than a threshold THh, the reference picture list generation unit 36 sets in the same manner. If the determinant value is equal to or less than the threshold THg. THh, the reference picture list generation unit 36 sets the reference pattern of the next P picture (Pd2) as a pattern including only reference pictures in the time direction. In the pattern determination, as described above, another determination method may be used, that is, the pattern of reference picture may be updated based on the comparison result of a determinant value and a threshold or the pattern of reference picture immediately before may be maintained.

If the reference pattern of pictures other than the anchor picture in the top field or the bottom field of the dependent view is never a pattern containing a reference picture in the parallax direction in a predetermined period, the characteristic quantity determined for the current picture is considered and stored as the parallax present characteristic quantity SATDiv of the subsequent pictures for each picture type.

Then, comparisons are made by using stored parallax present characteristic quantities and characteristic quantities and estimated characteristic quantities calculated for the current picture to determine the reference pattern of the next picture in the dependent view from comparison results. If determinations of the top field and the bottom field are made separately and the current picture is, for example, a picture of the top field, the determination of the next picture of the top field is made. If the top field and the bottom field are not distinguished and the current picture is, for example, a picture of the top field, the determination of a picture of the next bottom field is made.

If the current picture contains only time predictions, the reference picture list generation unit 36 compares the stored parallax present characteristic quantity SATDive immediately before and the characteristic quantity SATDdv calculated for the current picture. The reference picture list generation unit 36 determines the reference picture based on the comparison result.

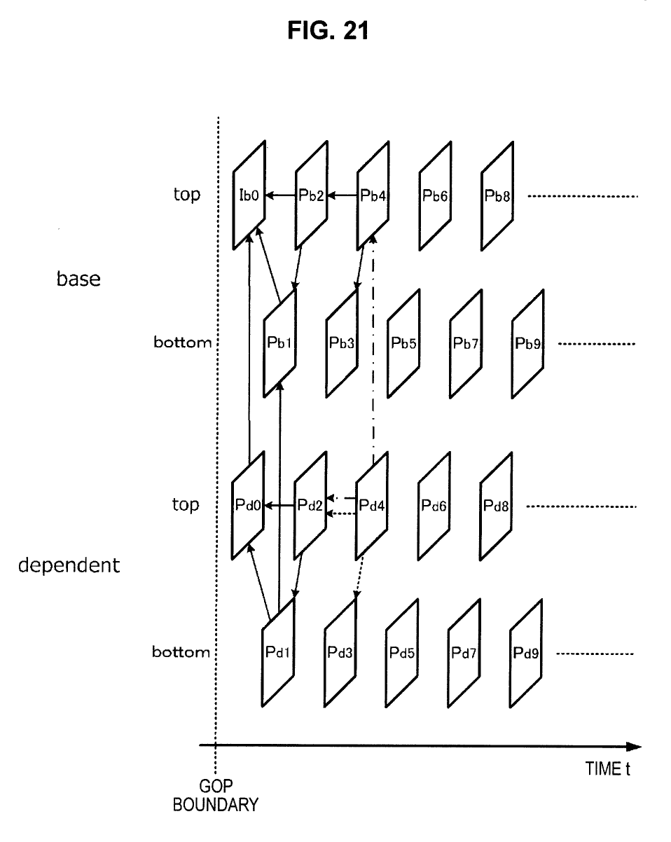

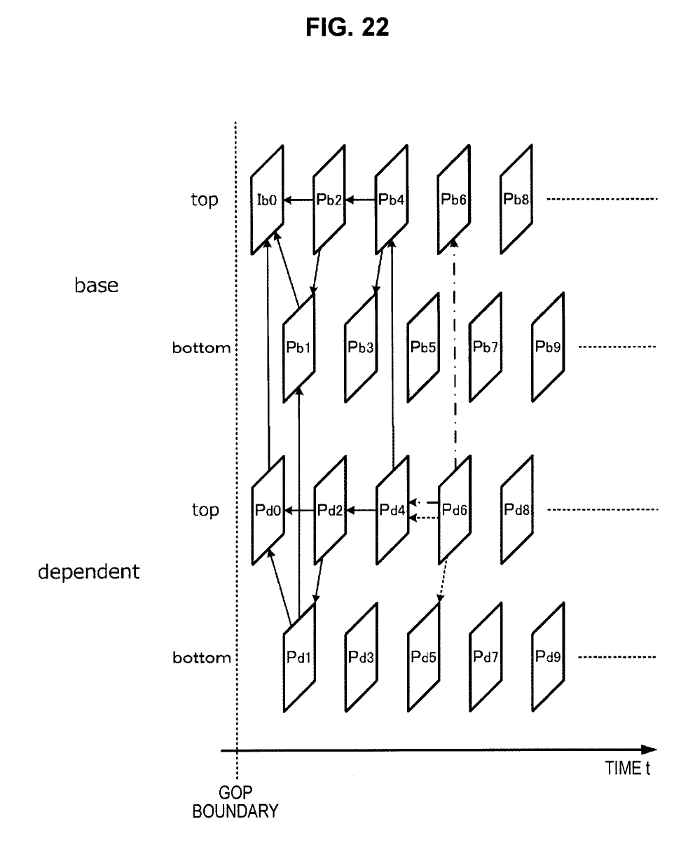

FIG. 21 is a diagram showing a case where the current picture contains only time predictions. FIGS. 21 and 22 show a case where determinations of the top field and the bottom field are made separately.

For comparison of characteristic quantities, a difference or ratio of two characteristic quantities is set as a determinant value and the determinant value is compared with a threshold. If the determinant value (SATDdv-SATDive) is larger than a threshold THi, the reference picture list generation unit 36 sets the reference pattern of the next P picture as a pattern including a reference picture in the parallax direction. If the determinant value (SATDdv/SATDive) is larger than a threshold THj, the reference picture list generation unit 36 sets in the same manner. Further, if the determinant value is equal to or less than the threshold, the reference picture list generation unit 36 sets the reference pattern of the next P picture as a pattern of only reference pictures in the time direction.

If for example, the reference pattern of the P picture (Pd2) is a pattern of only a reference picture in the time direction, the reference picture list generation unit 36 compares the stored parallax present characteristic quantity SATDive immediately before and the characteristic quantity SATDdv calculated for the P picture (Pd2). If the determinant value (SATDdv-SATDive) is larger than the threshold THi, the reference picture list generation unit 36 sets the reference pattern of the next P picture (Pd4) of the P picture (Pd2) as a pattern containing, as indicated by an arrow of an alternate long and short dash line in FIG. 21, a reference picture in the parallax direction. If the determinant value (SATDdv/SATDive) is larger than the threshold THj, the reference picture list generation unit 36 sets in the same manner. Further, if the determinant value is equal to or less than the threshold, the reference picture list generation unit 36 sets the reference pattern of the next P picture (Pd4) as a pattern of, as indicated by an arrow of a dotted line, only reference pictures in the time direction. The estimation processing information Psc (Psc=SATDdv/SATDbv) is calculated from characteristic quantities of the base view and the dependent view.

FIG. 22 is a diagram showing a case where the current picture contains a parallax prediction. If the reference pattern of the current picture is a pattern containing a reference picture in the parallax direction, the characteristic quantity generation unit 35 calculates the estimated characteristic quantity SATDtm. The estimated characteristic quantity SATDtm is calculated by multiplying the characteristic quantity SATDbv of the base view by the estimation processing information Psc. Further, the reference picture list generation unit 36 compares the estimated characteristic quantity SATDtm and the parallax present characteristic quantity SATDiv to set the reference pattern based on the comparison result.

For comparison of characteristic quantities, as described above, a difference or ratio of two characteristic quantities is set as a determinant value and the determinant value is compared with a threshold. If the determinant value (SATDtm-SATDiv) is larger than a threshold THk, the reference picture list generation unit 36 continues to set the reference pattern of the next picture as a pattern containing a reference picture in the parallax direction. If the determinant value (SATDtm/SATDiv) is larger than a threshold THm, the reference picture list generation unit 36 sets in the same manner. Further, if the determinant value is equal to or less than the threshold, the reference picture list generation unit 36 sets the reference pattern of the next picture as a pattern of only reference pictures in the time direction.

If for example, the reference pattern of the P picture (Pd4) is a pattern containing a reference picture in the parallax direction, the characteristic quantity generation unit 35 calculates the estimated characteristic quantity SATDtm by multiplying the characteristic quantity SATDbv of the P picture (Pb4) of the base view by the estimation processing information Psc. The reference picture list generation unit 36 compares the calculated estimated characteristic quantity SATDtm and the parallax present characteristic quantity SATDiv calculated for the P picture (Pd4). If the determinant value (SATDtm-SATDiv) is larger than the threshold THk, the reference picture list generation unit 36 continues to set the reference pattern of the next P picture (Pd6) as a pattern containing, as indicated by an arrow of an alternate long and short dash line in FIG. 22, a reference pattern in the parallax direction. If the determinant value (SATDtm/SATDiv) is larger than a threshold THm, the reference picture list generation unit 36 sets in the same manner. Further, if the determinant value is equal to or less than the threshold, the reference picture list generation unit 36 sets the reference pattern of the next P picture (Pd6) as a pattern of, as indicated by an arrow of a dotted line, only reference pictures in the time direction. The reference picture list generation unit 36 also considers and stores a parallax present characteristic quantity SATD-iv calculated for the current P picture as the parallax present characteristic quantity of the next P picture.

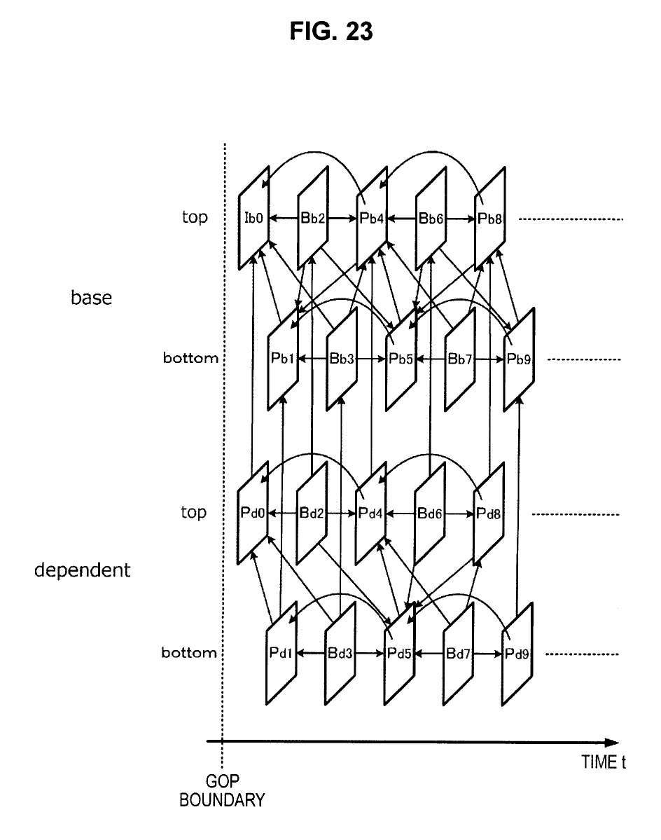

The above description provides a description when no B picture is contained, but if B pictures are contained, processing similar to the processing on P pictures is performed on B pictures. That is, the reference picture list generation unit 36 makes comparisons by using stored parallax present characteristic quantities and characteristic quantities and estimated characteristic quantities calculated for the current picture to determine the reference pattern of the next picture in the dependent view from comparison results. FIG. 23 illustrates the reference relationship when the base view and the dependent view in the interlaced material are made to have an equal number of reference pictures including B pictures. In FIG. 23, in the base view and the dependent view, the number of reference pictures for P pictures is set to 2 and the number of reference pictures for B pictures is set to 4.

Incidentally, the parallax present characteristic quantity SATDiv is updated at least once for the P picture at the head of GOP in the dependent view. However, if a pattern containing a reference picture in the parallax direction continues, the period in which the estimation processing information Psc is not updated will be longer because the characteristic quantity SATDdv in a reference pattern using a pattern of only a reference picture in the time direction is not calculated. The estimated characteristic quantity SATDtm is calculated, as described above, by multiplying the characteristic quantity SATDbv of the base view by the estimation processing information Psc and thus, reliability of the estimated characteristic quantity SATDtm becomes lower with an increasingly longer period in which the estimation processing information Psc is not updated. Therefore, there is a possibility that the reference picture list generation unit 36 may not be able to determine the reference pattern appropriately.

Thus, if the reference pattern is not set as a pattern of only reference pictures in the time direction in the predetermined period, the reference picture list generation unit 36 sets the reference pattern of the next picture as a pattern of only reference pictures in the time direction even for an interlaced material. By setting the reference pattern as a pattern of only reference pictures in the time direction in this manner, the reference picture list generation unit 36 causes the characteristic quantity generation unit 35 to update the estimation processing information Psc.

Even for an interlaced material, as described above, by performing processing similar to the processing for the progressive material, as many reference pictures in the time direction or pictures including the parallax direction as pictures of the base view can be selected to increase encoding efficiency. Because the base view and the dependent view have the same number of reference pictures, the amount of processing can be made equivalent for the base view and the dependent view.

### 7. Other Determination Operations of Reference Pattern

In the above embodiment, a case where SATD is used as the characteristic quantity is described, but the characteristic quantity is not limited to SAID calculated by the motion prediction/compensation unit 32. For example, SAD, the ratio of reference index obtained by the predicted image/optimal mode selection unit 33, the global motion vector, complexity obtained by the rate controller 18, camera work (fixed/pan/tilt/zoom), parallax information, or depth information can also be used as the characteristic quantity.

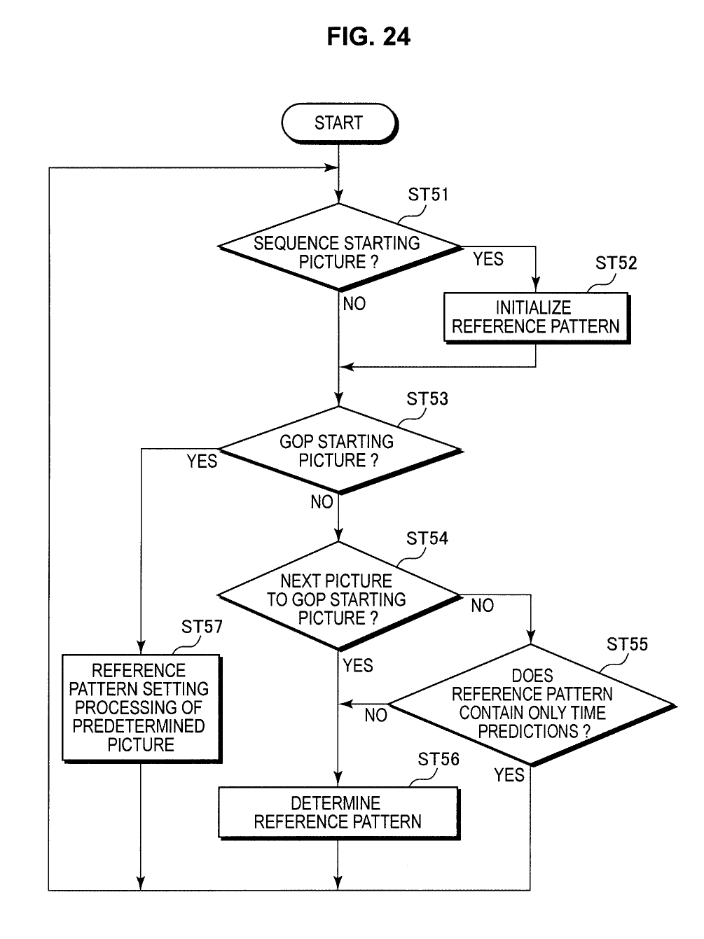

FIG. 24 is a flow chart showing the operation when the ratio of reference index is used as a characteristic quantity. In step ST51, the reference picture generation unit 36 determines whether the picture is the sequence starting picture. The reference picture generation unit 36 proceeds to step ST52 if the picture is the sequence starting picture and proceeds to step S153 if the picture is not the sequence starting picture.

In step ST52, the reference picture list generation unit 36 initializes the reference pattern. The reference picture list generation unit 36 initializes the reference pattern to a pattern of only reference pictures in the time direction before proceeding to step ST53.

In step ST53, the reference picture generation unit 36 determines whether the picture is the GOP starting picture. The reference picture generation unit 36 proceeds to step ST57 if the picture is not the next picture to the picture at the head of GOP and proceeds to step ST54 if the picture is the next picture to the picture at the head of GOP.

In step ST54, the reference picture generation unit 36 determines whether the picture is the next picture to the picture at the head of GOP. The reference picture generation unit 36 proceeds to step ST55 if the picture is not the GOP starting picture and proceeds to step ST56 if the picture is not the GOP starting picture.

In step ST55, the reference picture list generation unit 36 determines whether the reference pattern contains only time predictions. The reference picture list generation unit 36 returns to step ST51 if the reference pattern is a pattern of only reference pictures in the time direction and proceeds to step ST56 if the reference pattern is a pattern containing a reference picture in the parallax direction.

In step ST56, the reference picture list generation unit 36 determines the reference pattern. The reference picture list generation unit 36 compares indexes in the time direction and the parallax direction to determine whether the reference pattern is a pattern of only reference pictures in the time direction or a pattern containing a reference picture in the parallax direction based on the comparison result. If the ratio of reference index in the parallax direction to those in the time direction is larger than a threshold, the reference picture list generation unit 36 determines that the reference pattern is a pattern containing a reference picture in the parallax direction and if the ratio is equal to or less than the threshold, the reference picture list generation unit 36 determines that the reference pattern is a pattern of only reference pictures in the time direction before returning to step ST51.

In step ST57, the reference picture list generation unit 36 performs reference pattern setting processing of a predetermined picture. The reference picture list generation unit 36 determines that the reference pattern of the predetermined picture, that is, the GOP starting picture is a pattern containing a reference picture in the parallax direction before returning to step ST51.

Thus, when the ratio of reference index is used for determination, the reference pattern is determined to contain a parallax prediction if the ratio of reference index indicating a parallax prediction is larger than that indicating a time prediction for the picture (the next picture to the picture at the head of GOP) capable of typically using the time prediction and the parallax prediction. Also for subsequent pictures, a reference picture list may be generated based on comparison results after the reference index indicating a time prediction and that indicating a parallax prediction being compared. The image encoding apparatus 10 performs image encoding processing based on a reference picture list as described above.

If the picture is an interlaced material, reference pictures in the time direction in phase and in opposite phase can generally be referred to. If the reference pattern is set to a pattern containing a parallax prediction under the above conditions, it is necessary to delete one picture from in-phase/in-opposite-phase reference pictures in the time direction. That is, it is necessary to select one of in phase/parallax and in opposite phase/parallax as the reference pattern. As a method of determining a reference picture in which time direction to use, the ratio of reference index, global motion vector, or camera work information can be used.

The method of using the ratio of reference index will be described below. More specifically, the ratio of reference index of the base view will be used. A reference picture of the base view is in phase/in opposite phase and thus, reference pictures in the same phase as reference pictures used more frequently for prediction are included in a reference picture list.

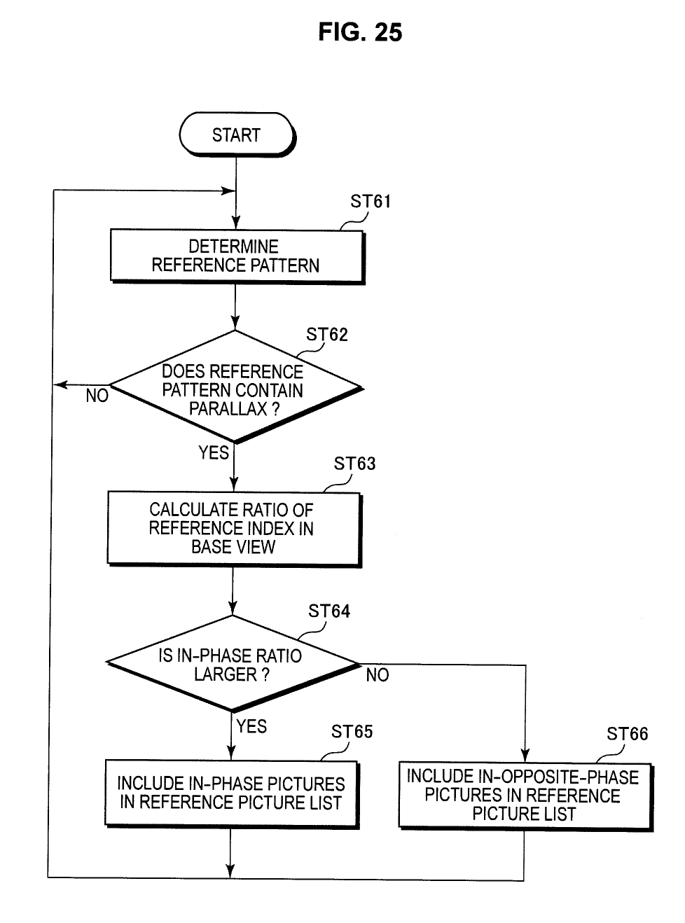

FIG. 25 is a flow chart showing the operation to determine whether to select a reference picture in phase or in opposite phase with the parallax by using the ratio of reference index.

In step ST61, the reference picture list generation unit 36 determines the reference pattern. The reference picture list generation unit 36 determines the reference pattern according to the ratio of reference index in the same manner as in FIG. 24 before proceeding to step ST62.

In step ST62, the reference picture list generation unit 36 determines whether the reference pattern has a parallax. The reference picture list generation unit 36 proceeds to step ST63 if the reference pattern is determined to be a pattern containing a reference picture in the parallax direction and terminates the processing if the reference pattern is determined to be a pattern of only reference pictures in the time direction.

In step ST63, the reference picture list generation unit 36 calculates the ratio of reference index in the base view. The reference picture list generation unit 36 calculates the ratio of referring to pictures in the same phase, that is, the same field and the ratio of referring to pictures in the opposite phase, that is, the different field based on reference indexes in a reference picture list of the base view before proceeding to step ST64.

In step ST64, the reference picture generation unit 36 determines whether the ratio of the same phase is larger. If the ratio of referring to pictures in the same phase is larger than the ratio of referring to pictures in opposite phase, the reference picture generation unit 36 proceeds to step ST65. Otherwise, the reference picture generation unit 36 proceeds to step ST66.

In step ST65, the reference picture generation unit 36 includes pictures in the same phase in the reference picture list. The reference picture list generation unit 36 includes pictures in the same phase in the reference picture list so that pictures referred to in the time direction are pictures in the same phase in a reference pattern in which a parallax prediction is made before terminating the processing.

In step ST66, the reference picture generation unit 36 includes pictures in opposite phase in the reference picture list. The reference picture list generation unit 36 includes pictures in opposite phase in the reference picture list so that pictures referred to in the time direction are pictures in opposite phase in a reference pattern in which a parallax prediction is made before terminating the processing.

In the reference pattern in the time direction only, pictures in the same phase and in opposite phase are included in the reference picture list.

If the reference picture list is generated as described above, pictures in the same phase or in opposite phase are selected based on the base view and included in the reference picture list in a reference pattern containing a parallax prediction and thus, reference pictures can be selected optimally to improve encoding efficiency. If the SAD value or the SATD value is used as the characteristic value, the reference picture list generation unit 36 may select pictures in the same phase and in opposite phase whose SAD value or SATD value is small.

Further, the global motion vector or camera work may be used as the characteristic quantity. If the camera is fixed, the background is at rest and it is better to include reference pictures in the same phase in which images in a portion at rest match in the reference picture list. If the camera is typically moving, by contrast, pictures in opposite phase whose temporal distance is close are more similar and thus, it is better to include reference pictures in opposite phase in the reference picture list. That is, if the value of the global motion vector is a value close to “0” or camera work information is fixed, the reference pattern is set as in phase/parallax. Otherwise (tilt/pan/zoom and so on), the reference pattern is set as in opposite phase/parallax. By using the global motion vector or camera work as the characteristic quantity as described above, reference pictures can optimally be selected.

Further, according to the present technology, lacking characteristic quantities are estimated from characteristic quantities of the base view at the same time or characteristic quantities of the dependent view in the past. However, characteristic quantities in the future may also be used as lacking characteristic quantities. For example, SATD of reduced images calculated when images are reduced in a simplified manner to make a motion prediction by using pictures in the future, rather than pictures to be encoded can be used.

### 8. Software Processing

A sequence of processing described herein may be performed by hardware, software, or a combined configuration of both. If processing is performed by software, a program in which a processing sequence is recorded is installed in a memory inside a computer incorporated into dedicated hardware to cause the computer to execute the program. Alternatively, the program may be installed on a general-purpose computer capable of performing various kinds of processing to cause the computer to execute the program.

For example, the program may be recorded in a hard disk or ROM (Read Only Memory) as a recording medium in advance. Alternatively, the program can be stored (recorded) temporarily or permanently in a removable recording medium such as a flexible disk, CD-ROM (Compact Disc Read Only Memory), MO (Magneto optical) disk, DVD (Digital Versatile Disc), magnetic disk, and semiconductor memory. Such a removable recording medium can be provided as so-called packaged software.

In addition to installing the program from a removable recording medium as described above onto a computer, the program may be wirelessly transferred from a download site to the computer or transferred to the computer by wire via a network such as LAN (Local Area Network) and the Internet and the computer can receive the program transferred as described above to install the program in a recording medium such as the built-in hard disk.

Steps describing a program include not only processing performed chronologically in the order described, but also processing that is not necessarily performed chronologically and is performed in parallel or individually.

### 9. Application Examples

The image encoding apparatus 10 according to the above embodiment using an image processing apparatus according to the present technology can be applied to various electronic devices such as transmitters for satellite broadcasting, cable broadcasting of cable TV and the like, delivery on the Internet, and delivery to terminals by cellular communication and recording apparatuses recording images media such as an optical disk, magnetic disk, and flash memory. Four application examples will be described below.

### First Application Example

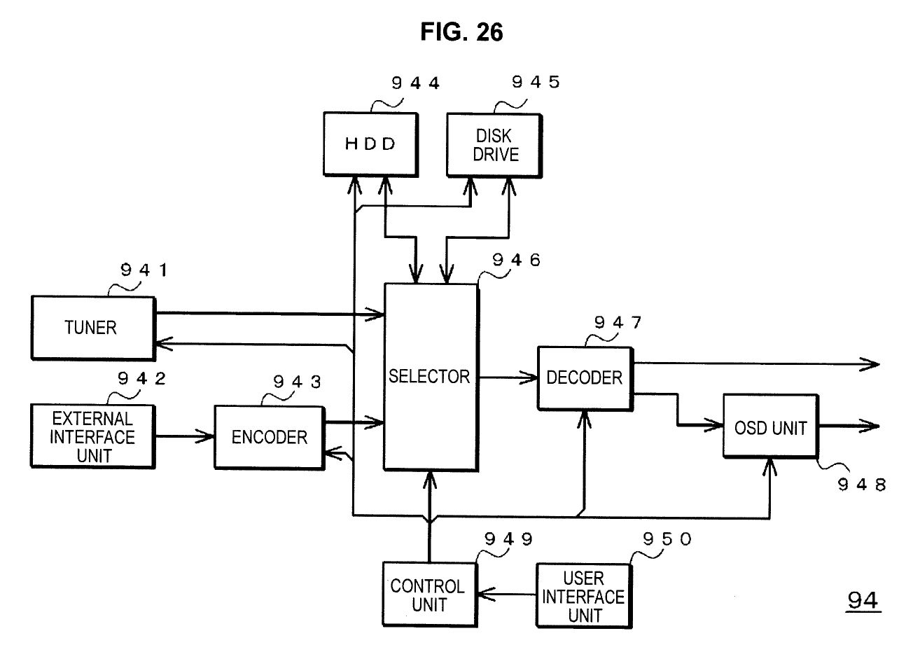

FIG. 26 is a diagram exemplifying the schematic configuration of a recording and reproducing apparatus to which the above embodiment is applied. A recording and reproducing apparatus 94 encodes and records audio data and video data of, for example, a received broadcasting program in a medium. The recording and reproducing apparatus 94 may also encode and record audio data and video data acquired from another apparatus in a recording medium. The recording and reproducing apparatus 94 reproduces data recorded in a recording medium through a monitor and a speaker according to user's instructions. At this point, the recording and reproducing apparatus 94 decodes audio data and video data.

The recording and reproducing apparatus 94 includes a tuner 941, an external interface unit 942, an encoder 943, an HDD (Hard Disk Drive) 944, a disk drive 945, a selector 946, a decoder 947, an OSD (On-Screen Display) unit 948, a control unit 949, and a user interface unit 950.

The tuner 941 extracts a signal of a desired channel from a broadcasting signal received via an antenna (not shown) and demodulates the extracted signal. Then, the tuner 941 outputs the demodulated encoded bit stream to the selector 946. That is, the tuner 941 acts as a transmission unit in the recording and reproducing apparatus 94.

The external interface unit 942 is an interface to connect the recording and reproducing apparatus 94 and an external device or a network. The external interface unit 942 may be, for example, the IEEE1394 interface, network interface, USB interface, or flash memory interface. For example, video data and audio data received via the external interface unit 942 is input into the encoder 943. That is, the external interface unit 942 acts as a transmission unit in the recording and reproducing apparatus 94.

If video data and audio data input from the external interface unit 942 are not encoded, the encoder 943 encodes the video data and audio data. Then, the encoder 943 outputs an encoded bit stream to the selector 946.

The HDD 944 records an encoded bit stream in which content data such as video and audio is compressed, various programs, and other data in an internal hard disk. The HDD 944 also reads data from the hard disk for video and audio reproduction.

The disk drive 945 records data on an inserted recording medium or reads data therefrom. Recording media inserted into the disk drive 945 include, for example, a DVD disk ((DVD-Video, DVD-RAM, DVD-R, DVD-RW, DVD+R, DVD+RW and so on) and a Blu-ray (registered trademark) disk. When video and audio are recorded, the selector 946 selects the encoded bit stream input from the tuner 941 or the encoder 943 and outputs the selected encoded bit stream to the HDD 944 or the disk drive 945. When video and audio are reproduced, the selector 946 outputs the encoded bit stream input from the HDD 944 or the disk drive 945 to the decoder 947.

The decoder 947 decodes an encoded bit stream to generate video data and audio data. Then, the decoder 947 outputs the generated video data to the OSD unit 948. The decoder 947 also outputs the generated audio data to an external speaker. The OSD unit 948 reproduces video data input from the decoder 947 to display the video. The OSD unit 948 may superimpose, for example, images of GUI such as a menu, a button, or a cursor on the video to be displayed.

The control unit 949 includes a processor such as a CPU and a memory such as a RAM and ROM. The memory stores a program executed by the CPU and program data. The program stored in the memory is read into the CPU and executed when, for example, the recording and reproducing apparatus 94 is started. The CPU controls the operation of the recording and reproducing apparatus 94 in accordance with an operation signal input from, for example, the user interface unit 950 by executing the program.

The user interface unit 950 is connected to the control unit 949. The user interface unit 950 includes, for example, buttons and switches for the user to operate the recording and reproducing apparatus 94 and a receiving unit of a remote control signal. The user interface unit 950 detects a user operation via such elements to generate an operation signal and outputs the generated operation signal to the control unit 949.

In the recording and reproducing apparatus 94 configured as described above, the encoder 943 has the function of the image encoding apparatus 10 according to the above embodiment. Accordingly, when multi-viewpoint pictures are encoded by the recording and reproducing apparatus 94, a reference picture list can be generated by selecting pictures so as to improve encoding efficiency.

### Second Application Example

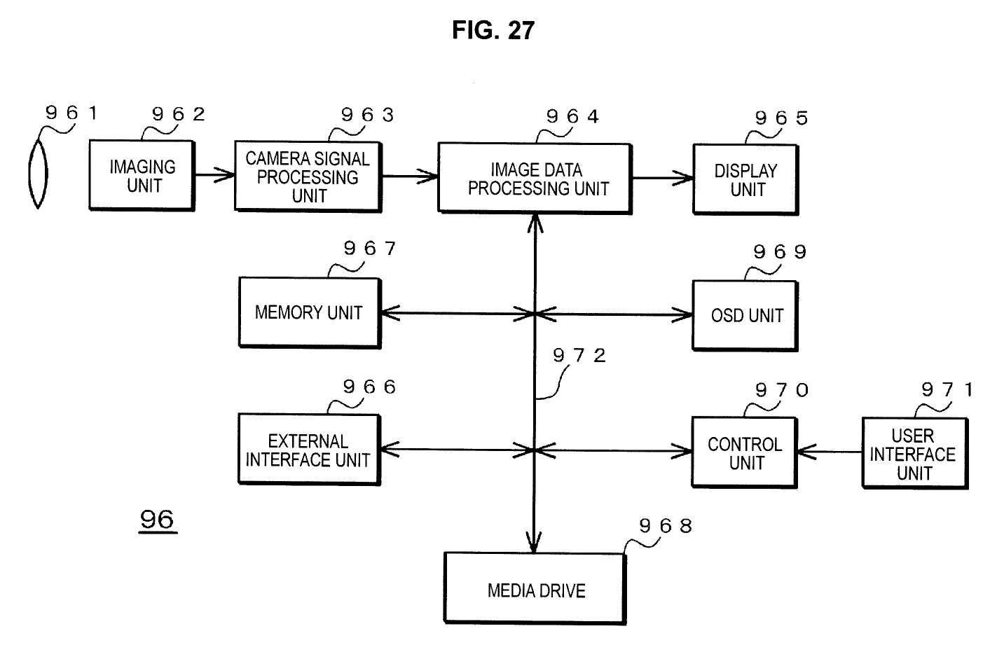

FIG. 27 is a diagram exemplifying the schematic configuration of an imaging apparatus to which the above embodiment is applied. An imaging apparatus 96 generates an image by picking up a subject and encodes and records image data in a recording medium.

The imaging apparatus 96 includes an optical block 961, an imaging unit 962, a camera signal processing unit 963, an image processing unit 964, a display unit 965, an external interface unit 966, a memory 967, a media drive 968, an OSD unit 969, a control unit 970, a user interface unit 971, and a bus 972.

The optical block 961 includes a focus lens and a diaphragm mechanism. The optical block 961 forms an optical image of a subject on an imaging surface of the imaging unit 962. The imaging unit 962 includes an image sensor such as a CCD or CMOS and converts an optical image formed on the imaging surface into an image signal as an electric signal by photoelectric conversion. Then, the imaging unit 962 outputs the image signal to the camera signal processing unit 963.

The camera signal processing unit 963 performs various kinds of camera signal processing such as the knee correction, gamma correction, and color correction on an image signal input from the imaging unit 962. The camera signal processing unit 963 outputs image data after the camera signal processing to the image processing unit 964.

The image processing unit 964 encodes image data input from the camera signal processing unit 963 to generate encoded data. Then, the image processing unit 964 outputs the generated encoded data to the external interface unit 966 or the media drive 968. The image processing unit 964 also decodes encoded data input from the external interface unit 966 or the media drive 968 to generate image data. Then, the image processing unit 964 outputs the generated image data to the display unit 965. The image processing unit 964 may also output image data input from the camera signal processing unit 963 to the display unit 965 to cause the display unit 965 to display an image. The image processing unit 964 may also superimpose display data acquired from the OSD unit 969 on an image output to the display unit 965.

The OSD unit 969 generates an image of GUI such as a menu, a button, or a cursor and outputs the generated image to the image processing unit 964.

The external interface unit 966 is constituted, for example, as a USB input/output terminal. The external interface unit 966 connects the imaging apparatus 96 and a printer when, for example, an image is printed. A drive is connected to the external interface unit 966 if necessary. A removable medium such as a magnetic disk or optical disk is inserted into the drive and a program read from the removable medium is installed in the imaging apparatus 96. Further, the external interface unit 966 may be configured as a network interface connected to a network such as LAN and the Internet. That is, the external interface unit 966 acts as a transmission unit in the imaging apparatus 96.

Recording media inserted into the media drive 968 may be any removable medium that can be read and written into such as a magnetic disk, magneto-optical disk, optical disk, and semiconductor memory. A recording medium may fixedly be inserted into the media drive 968 to constitute, for example, a non-portable storage unit such as a built-in hard disk drive and SSD (Solid State Drive).

The control unit 970 includes a processor such as a CPU and a memory such as a RAM and ROM. The memory stores a program executed by the CPU and program data. The program stored in the memory is read into the CPU and executed when, for example, the imaging apparatus 96 is started. The CPU controls the operation of the imaging apparatus 96 in accordance with an operation signal input from, for example, the user interface unit 971 by executing the program.

The user interface unit 971 is connected to the control unit 970. The user interface unit 971 includes, for example, buttons and switches for the user to operate the imaging apparatus 96. The user interface unit 971 detects a user operation via such elements to generate an operation signal and outputs the generated operation signal to the control unit 970.

The bus 972 mutually connects the image processing unit 964, the external interface unit 966, the memory 967, the media drive 968, the OSD unit 969, and the control unit 970.

In the imaging apparatus 96 configured as described above, the image processing unit 964 has the function of the image encoding apparatus 10 according to the above embodiment. Accordingly, when multi-viewpoint pictures are encoded by the imaging apparatus 96, a reference picture list can be generated by selecting pictures so that encoding efficiency is improved.

It should be understood by those skilled in the art that various modifications, combinations, sub-combinations and alterations may occur depending on design requirements and other factors insofar as they are within the scope of the appended claims or the equivalents thereof.

Furthermore, the present technology can also be configured as below.

(1) An image encoding apparatus, including:

a characteristic quantity generation unit that generates a characteristic quantity showing a correlation between pictures for each candidate of a reference picture, with a first viewpoint picture different in time direction from the first viewpoint picture and a second viewpoint picture different from the first viewpoint picture being set as the candidates of the reference picture; and

a reference picture list generation unit that generates a reference picture list by selecting as many reference pictures for the first viewpoint picture as the reference pictures for the second viewpoint picture from the candidates of the reference pictures based on the characteristic quantity.

(2) The image encoding apparatus according to (1),

wherein the reference picture list generation unit includes, in a case where a determinant value based on the characteristic quantity for a case where the first viewpoint picture is a GOP starting picture is equal to or less than a threshold, second viewpoint reference pictures in the reference picture list for a next picture, and includes, in a case where the determinant value is larger than the threshold, only the reference pictures in the time direction in the reference picture list for the next picture.

(3) The image encoding apparatus according to (1),

wherein the reference picture list generation unit updates a pattern of the reference pictures or maintains the pattern of the reference pictures immediately before based on a comparison result between a determinant value based on the characteristic quantity obtained when the first viewpoint picture is a GOP starting picture and a threshold.

(4) The image encoding apparatus according to any of (1) to (3),

wherein the reference picture list generation unit holds, in a case where second viewpoint reference pictures are included in the reference picture list, the characteristic quantity for a case where the second viewpoint reference pictures are included, and updates, in a case where the reference picture list contains only the reference pictures in the time direction for a predetermined period, the characteristic quantity which is held by the characteristic quantity calculated for the picture in a GOP starting frame or a starting picture for each field.

(5) The image encoding apparatus according to (4),

wherein, in a case where the reference picture list of the picture contains only the reference pictures in the time direction, the reference picture list generation unit compares the characteristic quantity calculated for the picture and the held characteristic quantity and selects the reference pictures for a next picture based on a comparison result.

(6) The image encoding apparatus according to any of (1) to (5),

wherein, in a case where the reference picture list of the picture includes second viewpoint reference pictures, the reference picture list generation unit selects the reference pictures for a next picture based on a comparison result between an estimated characteristic quantity estimating the characteristic quantity of only the reference pictures in the time direction and the characteristic quantity for a case where the second viewpoint reference pictures are included.

(7) The image encoding apparatus according to (6),

wherein the characteristic quantity generation unit generates in advance estimation processing information by using the characteristic quantity for a case where the reference picture list for the first viewpoint picture contains only the reference pictures in the time direction and the characteristic quantity for the second viewpoint picture, and calculates the estimated characteristic quantity from the characteristic quantity of the second viewpoint picture corresponding to the first viewpoint picture estimating the characteristic quantity and the estimation processing information.

(8) The image encoding apparatus according to (7),

wherein the reference picture list generation unit includes only the reference pictures in the time direction in the reference picture list in a case where a state in which the reference picture list contains the second viewpoint reference picture continues for a predetermined period, and

wherein the characteristic quantity generation unit updates the estimation processing information by the reference picture list being caused to contain only the reference pictures in the time direction.

(9) The image encoding apparatus according to any of (1) to (8),

wherein the characteristic quantity generation unit generates the characteristic quantity by using an SATD value or an SAD value.

(10) The image encoding apparatus according to (1),

wherein the characteristic quantity generation unit uses a ratio of a reference index as the characteristic quantity.

(11) The image encoding apparatus according to any of (1) to (10),

wherein the first and second viewpoint pictures are interlaced materials, and

wherein the reference picture list generation unit selects the reference picture in phase or in opposite phase from the reference pictures in the time direction based on the characteristic quantity, in a case where the reference picture list contains second viewpoint reference picture.

According to an image encoding apparatus, an image encoding method, and a program of the present technology, a characteristic quantity showing a correlation between pictures is calculated for each candidate of reference pictures, with a first viewpoint picture different in time direction from the first viewpoint picture and a second viewpoint picture different from the first viewpoint picture being set as the candidates of the reference picture. A reference picture list is generated by selecting as many reference pictures for the first viewpoint picture as the reference pictures for the second viewpoint picture from the candidates of the reference pictures based on the characteristic quantity. Therefore, a reference picture list in which the number of reference pictures is equal to that of the second viewpoint picture can be generated by selecting reference pictures from candidates of reference pictures in the time direction and the parallax direction in such a way that encoding efficiency is improved. Therefore, the present technology is appropriate for electronic devices recording or editing multi-viewpoint images.

The present disclosure contains subject matter related to that disclosed in Japanese Priority Patent Application JP 2011-173566 filed in the Japan Patent Office on Aug. 9, 2011, the entire content of which is hereby incorporated by reference.

What is claimed is:

1. An image encoding apparatus, comprising:
a characteristic quantity generation unit that generates a characteristic quantity showing a correlation between pictures for each candidate of a reference picture, with a first viewpoint picture different in time direction from the first viewpoint picture and a second viewpoint picture different from the first viewpoint picture being set as the candidates of the reference picture; and
a reference picture list generation unit that generates a reference picture list by selecting as many reference pictures for the first viewpoint picture as the reference pictures for the second viewpoint picture from the candidates of the reference pictures based on the characteristic quantity.

2. The image encoding apparatus according to claim 1,
wherein the reference picture list generation unit includes, in a case where a determinant value based on the characteristic quantity for a case where the first viewpoint picture is a GOP starting picture is equal to or less than a threshold, second viewpoint reference pictures in the reference picture list for a next picture, and includes, in a case where the determinant value is larger than the threshold, only the reference pictures in the time direction in the reference picture list for the next picture.

3. The image encoding apparatus according to claim 1,
wherein the reference picture list generation unit updates a pattern of the reference pictures or maintains the pattern of the reference pictures immediately before based on a comparison result between a determinant value based on the characteristic quantity obtained when the first viewpoint picture is a GOP starting picture and a threshold.

4. The image encoding apparatus according to claim 1,
wherein the reference picture list generation unit holds, in a case where second viewpoint reference pictures are included in the reference picture list, the characteristic quantity for a case where the second viewpoint reference pictures are included, and updates, in a case where the reference picture list contains only the reference pictures in the time direction for a predetermined period, the characteristic quantity which is held by the characteristic quantity calculated for the picture in a GOP starting frame or a starting picture for each field.

5. The image encoding apparatus according to claim 4,
wherein, in a case where the reference picture list of the picture contains only the reference pictures in the time direction, the reference picture list generation unit compares the characteristic quantity calculated for the picture and the held characteristic quantity and selects the reference pictures for a next picture based on a comparison result.

6. The image encoding apparatus according to claim 1,
wherein, in a case where the reference picture list of the picture includes second viewpoint reference pictures, the reference picture list generation unit selects the reference pictures for a next picture based on a comparison result between an estimated characteristic quantity estimating the characteristic quantity of only the reference pictures in the time direction and the characteristic quantity for a case where the second viewpoint reference pictures are included.

7. The image encoding apparatus according to claim 6,
wherein the characteristic quantity generation unit generates in advance estimation processing information by using the characteristic quantity for a case where the reference picture list for the first viewpoint picture contains only the reference pictures in the time direction and the characteristic quantity for the second viewpoint picture, and calculates the estimated characteristic quantity from the characteristic quantity of the second viewpoint picture corresponding to the first viewpoint picture estimating the characteristic quantity and the estimation processing information.

8. The image encoding apparatus according to claim 7,
wherein the reference picture list generation unit includes only the reference pictures in the time direction in the reference picture list in a case where a state in which the reference picture list contains the second viewpoint reference picture continues for a predetermined period, and
wherein the characteristic quantity generation unit updates the estimation processing information by the reference picture list being caused to contain only the reference pictures in the time direction.

9. The image encoding apparatus according to claim 1,
wherein the characteristic quantity generation unit generates the characteristic quantity by using an SATD value or an SAD value.

10. The image encoding apparatus according to claim 1,
wherein the characteristic quantity generation unit uses a ratio of a reference index as the characteristic quantity.

11. The image encoding apparatus according to claim 1,
wherein the first and second viewpoint pictures are interlaced materials, and
wherein the reference picture list generation unit selects the reference picture in phase or in opposite phase from the reference pictures in the time direction based on the characteristic quantity, in a case where the reference picture list contains second viewpoint reference picture.

12. An image encoding method, comprising:
generating a characteristic quantity showing a correlation between pictures for each candidate of a reference picture, with a first viewpoint picture different in time direction from the first viewpoint picture and a second viewpoint picture different from the first viewpoint picture being set as the candidates of the reference picture; and
generating a reference picture list by selecting as many reference pictures for the first viewpoint picture as the reference pictures for the second viewpoint picture from the candidates of the reference pictures based on the characteristic quantity.

13. A program for causing a computer to perform encoding processing of first and second viewpoint pictures by using a reference picture list, the program causing the computer to execute procedures of:
generating a characteristic quantity showing a correlation between pictures for each candidate of a reference picture, with the first viewpoint picture different in time direction from the first viewpoint picture and the second viewpoint picture different from the first viewpoint picture being set as the candidates of the reference picture; and
generating the reference picture list by selecting as many reference pictures for the first viewpoint picture as the reference pictures for the second viewpoint picture from the candidates of the reference pictures based on the characteristic quantity.
